(19) United States
(12) Patent Application Publication
(10) Pub. No.: US 2015/0058029 A1
(43) Pub. Date: Feb. 26, 2015

(54) Identifying Performance Levels of a Product Within Integrated Delivery Networks

(71) Applicants: Lingyun Su, Philadelphia, PA (US); Yuan Ren, Conshohocken, PA (US); Bo Peng, Beijing (CN); Xue Yu, Beijing (CN); Angeliki Cooney, Hoboken, NJ (US); Daniel Barton, Philadelpia, PA (US); Jeff Tomlinson, Hilton Head Island, SC (US)

(72) Inventors: Lingyun Su, Philadelphia, PA (US); Yuan Ren, Conshohocken, PA (US); Bo Peng, Beijing (CN); Xue Yu, Beijing (CN); Angeliki Cooney, Hoboken, NJ (US); Daniel Barton, Philadelpia, PA (US); Jeff Tomlinson, Hilton Head Island, SC (US)

(73) Assignee: IMS HEALTH INCORPORATED, Danbury, CT (US)

(21) Appl. No.: 13/974,833

(22) Filed: Aug. 23, 2013

(51) Int. Cl. G06Q 50/22; G06Q 30/02

(52) U.S. Cl. CPC G06Q 50/22; G06Q 30/0201
USPC 705/2

(57) ABSTRACT

The disclosure generally describes computer-implemented methods, software, and systems for modeling the possible outcomes of a negative event in the market place. A negative event may be any event that has a negative impact on the marketshare value for a product in a territory. The disclosure also describes, presenting marketing investments that will reduce impact on the marketshare based on the occurrence of a negative event, by an analytical infrastructure.

### BACKGROUND

An Integrated Delivery Network is a network of facilities and providers that work together to offer a continuum of care to a specific geographic area or market.

### OVERVIEW

The present disclosure relates to computer-implemented methods, software, and systems for identifying the role of Integrated Delivery Networks (IDNs) in assessing and simulating prescriber behavior. The disclosure relates to implementations that facilitate the accessing of information from actors within a health care system and processing the information by an analytical infrastructure.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example of an analytical infrastructure system implemented in a computing system 100.

FIG. 2 illustrates the various actors involved in affecting the treatment choice provided to a patient.

FIG. 3 illustrates an example of the role of various actors in determining a unified commercial strategy by the analytical infrastructure.

FIG. 4 is an example of a sales management tool architecture.

FIG. 5 is a flow chart of a process by which an analytical infrastructure uses accessed marketing data.

FIGS. 6-17 illustrate example user interfaces for user interaction with a webpage application of a sales management tool.

FIG. 18 is a flow chart of a process by which the analytical infrastructure uses accessed prescription data to display the performance level of a product.

FIGS. 19-22 illustrate example user interfaces of user interaction with a webpage application of a sales management tool.

FIG. 23 is a flow chart of a process by which an analytical infrastructure presents a marketing investment plan based on the occurrence of a negative event.

### DETAILED DESCRIPTION

This disclosure generally describes computer-implemented methods, software, and systems for determining the role of Integrated Delivery Networks (IDNs) on prescriber behavior using an analytic and reporting infrastructure. This disclosure also describes computer-implemented methods, software, and systems for determining a model role for the prescribing behavior of the prescribers affiliated with an IDN to establish a performance level of a drug.

The operation described below describes the influence of the various stake holders, such as payers, patients, pharmaceutical companies, prescribers, and IDNs on the selection of a prescription treatment choice by a physician. In some markets, pharmaceutical companies focus their commercial strategies on one stake holder, that is, the prescriber. Therefore analytical frameworks may measure the effect of commercial tactics as geared towards the physician. These commercial tactics may include coordinating sales representative calls to physicians, providing free drug samples to physicians' offices, grass roots (direct-to-consumer marketing) campaigns for new drugs, physician conferences, support for managed care contract designs with drug copays, and rebates offered to payers to cover a specific drug. The analytical tools may relate revenue spent in support of marketing strategies to the volume of sales of a particular drug.

There have been several changes to the healthcare environment and new stake holders have had an increasingly large effect of the selection of prescription choice, more so than, the physician prescribing the drug. In particular, the increasing number of Integrated Delivery Networks has greatly impacted the selection of prescription drug choice by physicians. An IDN is a network of facilities and providers that work together to offer a continuum of care to a specific geographic area or market and is type of managed care organization. Health Maintenance Organization (HMO), Accountable Care Organizations (ACO), and Preferred Provider Organization (PPO) represent managed care organizations. For the purpose of this application, the term IDN may be used to describe HMO, ACO and/or PPO organizations.

IDNs may have implemented treatment guidelines and protocols that must be upheld by physicians within the network and therefore, by the nature of the IDN structure, prescription choice is influenced by an IDN presence. IDNs often require evidence of drug therapeutic effectiveness and costly effectiveness is also very important to the successful performance of an IDN. IDNs may even restrict pharmaceutical companies' sale representatives from promoting products to members of the IDN.

Thus, payers may be a stake holder that has increasingly influenced physicians on treatment choice. Both private and government payers have increased the demand for affordable treatment options for patients. Patients have also, over the years, increased their influence of treatment choice through self-advocacy and better awareness of the available treatment options.

The operation described herein allows pharmaceutical companies to understand the influence of the various stake holders involved in the selection of treatment choice by a physician. Pharmaceutical companies may use an analytical infrastructure for allocating commercial resources across the sales, marketing and managed markets strategies on a geographical granular level. The analytical framework developed may be implemented on a webpage and used by pharmaceutical companies to generate and manage marketing resources for example, time, staffing and budgets.

The operation described herein further describes, determining which IDN pharmaceutical companies should target to increase the marketshare of a product within the IDN and ultimately increase the nationwide marketshare of the product. The analytical framework may evaluate the performance level of a particular drug within an IDN to determine if the performance level may be increased. In some implementations, the analytical framework may evaluate, by how much, the performance level of a particular drug can be increased. The analytical infrastructure may use prescription data to determine a model role for the prescribing behavior of the prescribers afflicted with an IDN to establish a performance level of a drug.

The operation described herein further describes a sales investment tool that can be used by pharmaceutical companies to model the possible outcomes of a negative event in the market place. A negative event may be any event that has a negative impact on the marketshare value for a product in a territory. The sales investment tool may propose different marketing investments to present different loss of revenue based on the proposed marketing investments. In some implementations, the analytical framework may present marketing investments that will reduce impact on the marketshare based on the occurrence of a negative event.

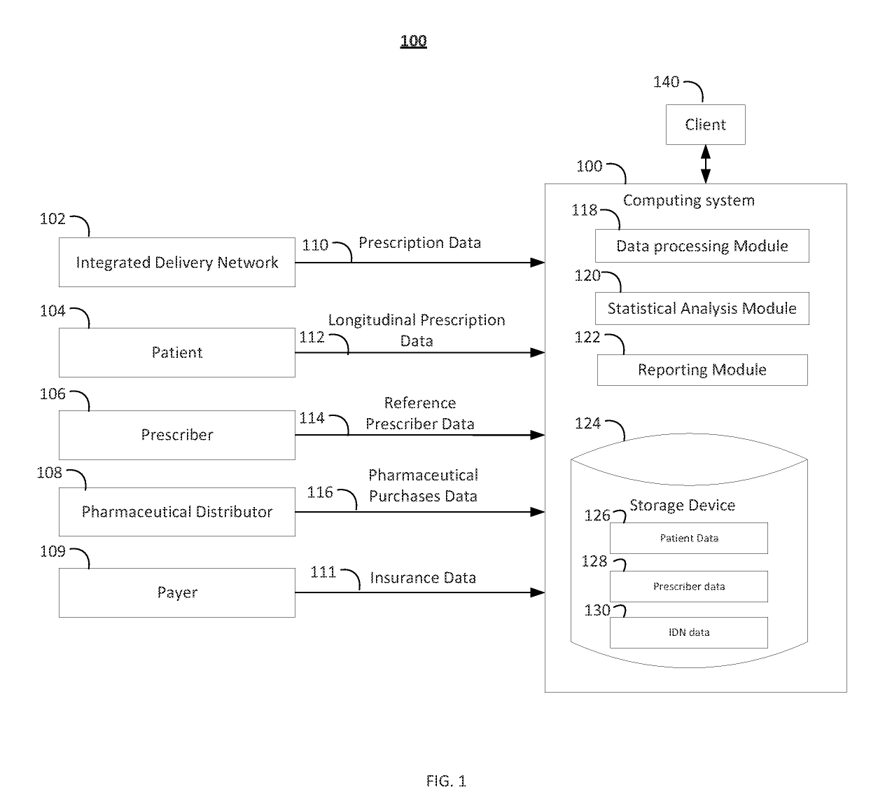

FIG. 1 illustrates an example analytical infrastructure system implemented in a computing system 100. The computing system may be implemented as a data processing apparatus that is capable of providing the functionality discussed herein, and may include any appropriate combination of processors, memory, and other hardware and software that can receive appropriate medical data and process the data as discussed below. At a high-level, the illustrated example computing system 100 receives various data from sources that are participants in the healthcare process. The sources may include IDNs 102, patient system 104, prescriber system 106, pharmaceutical distributors 108, and payer system 109. The data may include physician prescription data 110, longitudinal patient data 112, reference prescriber data 114, pharmaceutical purchase data 116, and payers prescription data. In some implementations, the data may include social media data.

FIG. 1 illustrates the process by which an analytical infrastructure is able to integrate data received about treatment choice, for example, from patient system 104 or from prescriber system 106, with other data sources available in IMS, such as IDNs 102, pharmaceutical distributors 108, and payer system 109. The data from patient system 104 is not restricted to longitudinal patient data 112 but may include any data from a health care provider or the prescriber system 106. The data may include prescription information related to the patient, for example the recent prescriptions written to the patient and whether or not the prescription drug was covered by the patient's payer or insurance company. It is important to understand that the system may be configured to preserve patient privacy, and will not store nominative data in an aggregated database but only de-identified data. Nominative data for an individual can be compared to the relevant aggregated data, but this may be achieved by using aggregated values in the individual patient application, not by keeping nominative records for multiple patients in a single database. Also, the integration of data from sources other than the user and their medical professionals may be achieved on a de-identified basis except in the instance that the individual gives permission to use their identity information (name, location, gender and age) for the purpose of providing them with their information from another source, such as pharmaceutical purchase data 116 from pharmacies.

The physician prescription data 110 may include data regarding prescriptions prescribed by physicians within an IDN. The prescription data 110 may be received directly from one or more IDNs 102 and represent data reflecting all prescriptions for pharmaceutical products issued by physicians within the one or more IDNs 102, including information about the type of prescription used to obtain the product and the payment method used to purchase the product. As noted previously, this information may be sanitized and aggregated to protect patient privacy. The prescription data may include the total revenue spent on prescriptions based on the specific drug. In some implementations, the data may be based on the total revenue spent on a specific drug in a specific geographic location. The one or more IDNs may provide the retail prescription data 110 on a periodic basis (e.g., every week or month). Though FIG. 1 shows the prescription data 110 being provided directly from the one or more IDNs 102 to the computing system 100, the prescription data 110 may be collected by one or more other intermediate systems and then provided to the computing system 100. If intermediate systems are used, the aggregation and sanitization of the retail prescription data 110 may potentially be performed by the intermediate systems.

The longitudinal patient data 112 may include sanitized retail patient-level data for the one or more patient systems 104. For example, the longitudinal patient data 112 may include information about retail pharmacy-sourced prescription insurance claims, retail pharmaceutical scripts, and/or patient profile data. Longitudinal patient data 112 includes information about aspects of care for the one or more patient systems 104. Though FIG. 1 illustrates the longitudinal patient data 112 as being received by the computing system 100 directly from one or more patient systems 104, the longitudinal patient data 112 may be collected by one or more other systems and then provided to the computing system 100 in a manner analogous to the similar approach discussed for retail prescription data 110. Moreover, the longitudinal patient data 112 may not originate from the one or more patient systems 104, but may rather be provided by one or more prescribers/physicians with whom patient interacts, insurance companies to which a patient submits insurance claims, and/or retailers at which a patient purchases a pharmaceutical product. In some implementations the longitudinal patient data 112 may originate from one or more pharmaceutical companies.

The reference prescriber data 114 may include background information for one or more prescribers 106. For example, the reference prescriber data 114 may include a prescriber's demographic information, address, affiliations, authorization data (e.g., DEA, AOA, SLN, and/or NPI numbers), profession, and/or specialty. While most prescribers will be medical doctors, other healthcare professionals such as physician-assistants or nurse practitioners may also be prescriber systems 106. Though FIG. 1 illustrates the reference prescriber data 114 as being received by the computing system 100 directly from one or more prescriber systems 106, the reference prescriber data 114 may be collected by one or more other systems and then provided to the computing system 100 in a manner analogous to the similar approach discussed for retail prescription data 110. Moreover, the reference prescriber data 114 may not originate from the one or more prescriber systems 106, but rather be created and/or maintained by one or more other entities (e.g., government agencies or professional medical organizations) that track information about the prescribing behavior of prescribers 106.

The pharmaceutical purchase data 116 may include information about pharmaceutical purchases made from distributors 108 (e.g., pharmaceutical wholesalers or manufacturers). For example, the pharmaceutical purchase data 116 may include information about the outlet from which a pharmaceutical product is purchased, the type of pharmaceutical product purchased, the location of both the purchaser and seller of the pharmaceutical product, when the purchase was conducted, and/or the amount of a pharmaceutical product that was purchased. Though FIG. 1 illustrates the pharmaceutical purchase data 116 as being received by the computing system 100 directly from one or more distributors 108, the pharmaceutical purchase data 116 may be collected by one or more other systems and then provided to the computing system 100 in a manner analogous to the similar approach discussed for retail prescription data 110. Moreover, the pharmaceutical purchase data 116 may not originate from the one or more distributors 108, but rather be provided by the purchaser of the pharmaceutical product (e.g., a retail outlet).

The insurance data 111 may include information about insurance companies covering the cost of prescriptions. A payer may be the insurance company that covers a patient, or in the case where the patient does not have insurance, and is covered by Medicaid the payer may be the government. For example, the insurance data 111 may include information about how much of a prescription's cost was covered by the insurance company or by Medicaid. Though FIG. 1 illustrates the insurance data 111 as being received by the computing system 100 directly from one or more payer system 109, the insurance data 111 may be collected by one or more other systems and then provided to the computing system 100.

The various types of data just discussed, which may include prescription data 110, longitudinal prescription data 112, reference prescriber data 114, pharmaceutical purchases data 116, and insurance data 111, are received by computing system 100 in order to derive conclusions based on the data. As noted previously, by the time the data is received by computing system 100, it should have been sanitized so that the data does not include private or confidential information that computing system 100 should not able to access.

For illustrative purposes, computing system 100 will be described as including a data processing module 118, a statistical analysis module 120, a reporting module 122, and a storage device 124. However, the computing system 100 may be any computing platform capable of performing the described functions. The computing system 100 may include one or more servers that may include hardware, software, or a combination of both for performing the described functions. Moreover, the data processing module 118, the statistical analysis module 120, and the reporting module 122 may be implemented together or separately in hardware and/or software. Though the data processing module 118, the statistical analysis module 120, and the reporting module 122 will be described as each carrying out certain functionality, the described functionality of each of these modules may be performed by one or more other modules in conjunction with or in place of the described module.

The data processing module 118 receives and processes one or more of prescription data 110, longitudinal patient data 112, reference prescriber data 114, pharmaceutical purchase data 116, and insurance data 111. In processing the received data, the data processing module 118 may filter and/or mine the prescription data 110, longitudinal patient data 112, reference prescriber data 114, pharmaceutical purchase data 116, and insurance data for specific information. The data processing module 118 may filter and/or mine the received retail prescription data 110, longitudinal patient data 112, reference prescriber data 114, pharmaceutical purchase data 116, and insurance data 111 for specific pharmaceuticals. Thus, any received retail prescription data 110, longitudinal patient data 112, reference prescriber data 114, pharmaceutical purchase data 116, and insurance data 111 that regards pharmaceutical products that are not classified as being associated with a tracked compound or prescription may be disregarded. For example, the received data may be processed by data processing module 118 so as to track use of a specific antibiotic, or of antibiotics in general.

After processing the received prescription data 110, longitudinal patient data 112, reference prescriber data 114, pharmaceutical purchase data 116, and insurance data 111, the data processing module 118 aggregates the processed data into patient data 126, prescriber data 128, and outlet data 130. These groups of data may be stored in storage device 124. In some implementations, the data processing module 118 may create profiles for each patient, prescriber, and the IDN for which data is received.

Prescription data 110 may include prescription information from prescriptions prescribed by a physician within an IDN, information about one or more patients that were prescribed pharmaceutical products, and information about one or more prescribers within the IDN. In this example, data processing module 118 would add information contained in the received prescription data 110 into profiles associated with the IDN, the one or more patients, and the one or more prescribers. In another example, longitudinal patient data 112 may include information about a patient that received prescriptions for a pharmaceutical product and information about one or more prescribers from which the patient received the prescriptions. In this example, data processing module 118 would add information contained in the received longitudinal patient data 112 into profiles associated with the patient and the one or more prescribers.

In other implementations, the data processing module 118 may simply sort and store, in storage device 124, processed prescription data 110, longitudinal patient data 112, reference prescriber data 114, pharmaceutical purchase data 116 and insurance data, the data processing module 118 for later use by other modules.

For each patient system 104, the patient data 126 may include any information related to the prescription and/or sale of one or more types of pharmaceutical products. Patient data 126 may include the quantity of each type of pharmaceutical product the patient has purchased, cumulative days' supply of a pharmaceutical product the patient should still have, cumulative dosage of a pharmaceutical product, medication possession ratio, the number and/or name of doctors from which the patient has received scripts, the number and/or name of retail outlets from which the patient has purchased pharmaceutical products, and/or information regarding the payment method(s) used by the patient when purchasing pharmaceutical products (e.g., cash or insurance). In some implementations, patient data 126 may include demographic information.

The prescriber data 128 received from the prescriber system 106, may include any information related to prescriptions written by an identified prescriber for one or more types of pharmaceutical products and the patients to whom the prescriptions were written. Prescriber data 128 may include the quantity of one or more types of pharmaceutical products for which the prescriber has written a prescription, the percentage of prescriptions for one or more types of pharmaceutical products written by a prescriber in relation to the total number prescriptions written by the prescriber, the percentage of prescriptions for one or more types of pharmaceutical products that are paid for with cash, and/or the number of patients for whom the prescriber has written a prescription for one or more types of pharmaceutical products and who currently have a supply of the one or more types of pharmaceutical products that exceeds a threshold. Prescriber data 128 may also include information about which IDN the prescriber is related to if any.

The IDN data 130 may include any information related to prescriptions written to patients for more types of pharmaceutical products, and/or prescribers who wrote the prescriptions. For example, the IDN data 130 may include the quantity of one or more types of pharmaceutical products prescribed by an identified physician within an IDN.

The statistical analysis module 120 uses the patient data 126, prescriber data 128 and/or IDN data 130 to rate and rank individual patients, prescribers, and IDNs. In some implementations, statistical analysis module 120 may compare one or more elements of the patient data 126 corresponding to a patient to averages of the one or more elements of the patient data 126 across a set of patients. Based on the comparison of the one or more elements of the patient data 126, the statistical analysis module 120 may assign one or more ratings to a patient. In other words, for each element of the patient data 126 (e.g., quantity of each type of pharmaceutical product the patient has purchased and percentage of purchases that were made with cash), the statistical analysis module 120 may assign a rating to a patient that reflects how an element of the patient data 126 compares to that same element of other patients in a set with respect to these calculated statistics. Patients in the set used in the comparison may be patients in the same location (e.g., country, state, city, or zip code), patients who share similar patient data (e.g., medical diagnosis or demographic information), and/or patients who share some other relationship.

Similarly, the statistical analysis module 120 may compare one or more elements of the prescriber data 128 corresponding to a prescriber to averages of the one or more elements of the prescriber data 128 across a set of related prescribers. Based on the comparison of the one or more elements of the prescriber data 128, the statistical analysis module 120 may assign one or more ratings to a prescriber. Prescribers in the set used in the comparison may be prescribers in the same location (e.g., country, state, city, or zip code), prescribers who share similar professional data (e.g., practice area or demographic information), and/or prescribers who share some other relationship. The statistical analysis module 120 may be able to derive conclusions for prescribers from the prescriber data 128, in a manner similar to that used for the patient data. For example, it may determine that general practitioners in one county tend to prescribe generic drugs with patients with epilepsy, while neurologists are more likely to use branded drugs for their patients with a similar diagnosis. These determinations may, for example, be used to suggest that a pharmaceutical company should promote a new anticonvulsant more heavily to neurologists than to general practitioners.

The statistical analysis module 120 may also compare one or more elements of the IDN data 130 corresponding to an IDN to averages of the one or more elements of the IDN data 130 across a set of related IDN outlets. Based on the comparison of the one or more elements of the IDN data 130, the statistical analysis module 120 may assign one or more ratings to an IDN. Retail outlets in the set used in the comparison may be retail outlets in the same location (e.g., country, state, city, or zip code), prescribers who share similar commercial data (e.g., size of the retail outlet), and/or prescribers who share some other relationship. For example, the data may indicate that certain drugs are more often bought at rural pharmacies, and other drugs are bought at urban pharmacies. For example, these determinations may suggest that pharmacies should stock more antihistamines for pollen allergies at their rural branches.

The ratings assigned to a patient, prescriber, and/or retail outlet by the statistical analysis module 120 may be normalized numbers that reflect the analysis performed with regard to an element of the patient data 126, prescriber data 128 and/or outlet data 130. In some implementations, the ratings determined by the statistical analysis module 120 may be updated on a periodic basis (e.g., weekly or monthly) or updated any time new data regarding the element corresponding to the rating is received by the computer system 100. Alternatively, in some implementations, the ratings determined by the statistical analysis module 120 may be calculated every time the statistical analysis module 120 receives a query for the ratings.

The statistical analysis module 120 may also calculate a composite rating for each patient, prescriber, and/or retail outlet for which data has been received by the computer system 100. In some implementations, the statistical analysis module 120 may weight each of the individual element ratings associated with a patient, prescriber, or retail outlet and apply an equation to calculate a composite of the individual element ratings. Alternatively, in some implementations, the statistical analysis module 120 may select a proper subset of the available individual element ratings and calculate a composite rating based on the selected individual element ratings.

In some implementations, the statistical analysis module 120 may calculate other metrics. For example, that statistical analysis module may calculate the potential decrease in market size with a change in payer structure. For example, the statistical analysis module may calculate that there may be a limit in market size by 75% if, for a specific geographical area, where most of the residence are supported under a tier three coverage program (that is designed to cater to low income residence) if there were to be an introduction of a tier one coverage plan. The statistical analysis module 120 may calculate other statistical measures. For example, the statistical analysis module 120 may calculate means or standard deviations.

In some implementations, the statistical analysis module 120 may rank patient, prescriber, and/or retail outlet with respect to one another based on the determined ratings. For example, the statistical analysis module 120 may rank all of the patients in a given location (e.g., a zip code) based on each patient's composite rating. Such an approach allows consideration of patient information for a population in a specific location, which is helpful because the patient behavior of interest may be for a localized population. In another example, the statistical analysis module 120 may rank all of the prescribers who are oncologists in a given state based on each prescriber rating related to the quantity of one or more types of pharmaceutical products for which the prescriber has written a prescription (i.e., an element of the prescriber data 128). Such an approach may be useful because specialists may prescribe differently than generalists and it may be of interest to compare the care strategies used by these different groups of prescribers, as discussed above.

In some implementations, the statistical analysis module 120 may use the data collected to generate a modeled rule for an IDN identified as having a market presence. In these implementations, the system may access the historical prescription data, longitudinal prescription data, prescriber data, pharmaceutical purchase data and insurance data to identify the presence of an influence of an IDN. The data uses the demographic information to determine the geographical area influenced by the IDN. For example, prescriber data may include an identifier that is used to identify the IDN the prescriber is affiliated with, if any. The insurance data may also be used to identify the market presence of one or more IDNs. The statistical analysis module 120 may use the data for a specified geographical area to determine the change in market size for a particular product due to the presence of one or more IDNs or a government program within the area. In these implementations, the system may use data from other geographical areas that may not be influenced by the same IDNs or government programs to calculate a marketshare for a product and project the calculated marketshare value for the geographical area in analysis. For example, the statistical module may predict a marketshare for a product in a geographic area to be decreased by 45 percent due the influence of one or more IDNs or government programs. The IDNs or government program in the mentioned example may not support the product patients treated within the network and therefore cause an overall decrease in the market presence of the product.

In these implementations, the statistical analysis module 120 may use the generated modeled rule to predict the prescribing patterns of one or more physicians affiliated to an IDN that has been identified as having a market presence. For example, the statistical ranking module may access prescriber data obtained over the first quarters of a year to predict prescribing patterns of a physician for the second and third quarters of the year. In another example, the statistical analysis module may be able to predict the number of prescriptions prescribed by a prescriber for the upcoming month based on the modeled rule. The prescriber data may include the number of prescriptions written for a particular product each month, the number of repeated prescriptions that the prescriber wrote, i.e. the same prescription for the same patient. The data may also include the details with respect to the prescriber's behavior related to which product was prescribed for treating a specific ailment. For example, the data may include that a prescriber prescribed Lipitor to 95 patients suffering from high cholesterol, but prescribed Crestor for 30 of the patients with the same medical condition.

The reporting module 122 prepares reports based on the ratings and/or rankings calculated by the statistical analysis module 120. The reports prepared by the reporting module 122 may include one or more of the ratings calculated by the statistical analysis module 120 as well as any other data contained in the patient data 126, prescriber data 128 and/or outlet data 130. For example, a report generated by the reporting system may include composite ratings for all prescribers in a given state for a particular pharmaceutical product (e.g., oxycodone—a controlled substance).

The system shown may be filtered and/or mined based on any one or more criteria associated with a patient, prescriber, and/or retail outlet. The reports may be filtered and/or mined based on location, type pharmaceutical product, medical specialty of a prescriber, category of a retail outlet (e.g., large chain retail outlet), and or one or more ratings calculated by the statistical analysis module 120. In other words, any data received and processed by the data processing module 118 or any ratings or rankings calculated by the statistical analysis module 120 may be included in or used to filter and/or mine the data included in a report.

Additionally, in some implementations, the reports generated may be either dynamic or static. The reporting module 122 may generate a report that includes data presented in one or more static formats (e.g., a chart, a graph, or a table) without providing any mechanism for altering the format and/or manipulating the data presented in the report. In such an implementation, the data presentation is generated and saved without incorporating functionality to update the data presentation. In some implementations, the reporting module 122 provides a static report in a PDF, spreadsheet, or XML format. Such a format generally provides an understanding of the reporting module 122 as textual data or a visualization, but other forms of presenting conclusions such as audio, video, or an animation are not excluded as potential results from reporting module 122. The reporting module 122 may provide a static report in a PowerPoint format.

Additionally or alternatively, the reporting module 122 may generate a report that includes controls allowing a user to alter and/or manipulate the report itself interactively. For example, the reporting system may provide a dynamic report in the form of an HTML document that itself includes controls for filtering, manipulating, and/or ordering the data displayed in the report. Moreover, a dynamic report may include the capability of switching between numerous visual representations of the information included in the dynamic report. In some implementations, a dynamic report may provide direct access as selected by a user to some or all of the patient data 126, prescriber data 128 and/or outlet data 130 prepared by the data processing module 118 and/or the statistical analysis module 120, as opposed to allowing access to only data and/or ratings included in the report itself.

One or more clients 140 may interface with the computing system 100 to request and receive reports created by the reporting system. In some implementations, the one or more clients 140 may include a web browser that provides Internet-based access to the computing system 100. Through the web browser, a user of a client 140 (e.g., a wholesaler, a retail outlet, or a prescriber) may request a static or dynamic report from the reporting system as discussed above.

There may be any number of clients 140 associated with, or external to, the example computing system 100. While the illustrated example computing system 100 is shown in communication with one client 140, alternative implementations of the example computing system 100 may communicate with any number of clients 140 suitable to the purposes of the example computing system 100. Further, the term “client” and “user” may be used interchangeably as appropriate without departing from the scope of this disclosure. Moreover, while the client 140 is described in terms of being used by a single user, this disclosure contemplates that many users may share the use of one computer, or that one user may use multiple computers.

The illustrated client 140 is intended to encompass computing devices such as a desktop computer, laptop/notebook computer, wireless data port, smartphone, personal digital assistant (PDA), tablet computing device, one or more processors within these devices, or any other suitable processing device. For example, the client 140 may include a computer that includes an input device, such as a keypad, touch screen, or other device that can accept user information, and an output device that conveys information associated with the operation of the computing system 100. The input device may be used by client 140 to provide instructions to computing system 100 that computing system 100 can execute to provide information requested by client 140 from the various data that computing system 100 receives.

In some implementations, functionality described as being performed by the computing system 100 may be performed by the client 140. For example, the computing system 100 may provide a client 140 with direct access to the ratings and rankings calculated by the statistical analysis module 120. As a result, some or all of the functionality described as being performed by the reporting module 122 may be performed locally by the client 140. The analytical infrastructure may be supported on a webpage application that a client may use to view the data received by the computing system at the analytical infrastructure.

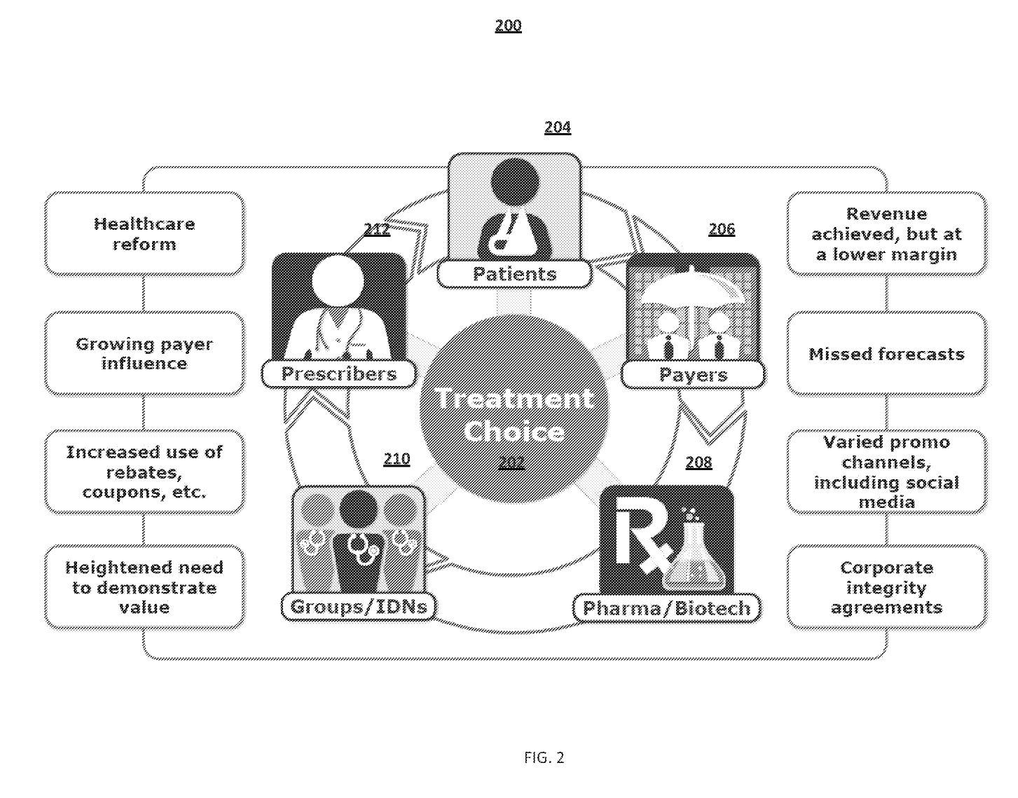

FIG. 2 illustrates the various stakeholders and other factors involved in affecting the treatment choice provided to a patient. Treatment choice 202 is the choice of prescription drug selected from a wide range of prescription drugs which may be used to treat a specific patient condition. Several various factors may affect the treatment choice of a patient as illustrated in FIG. 2. A patient is the person being treated for a specific condition and in need of a prescription drug. Patients have recently begun to increase their influence on the selection of prescription choice through self-advocacy and awareness of health conditions and available treatments. The increase in awareness by patients has occurred though electronic and social media, and also due to direct to consumer advertising from manufacturer. There has also been an increase in the number of patient advocacy organizations that help make patients aware of treatment choices and help to increase the influence of patients on treatment choice.

Payers 206 may also influence the treatment choice provided to a patient. A payer may be the insurance company of the patient, or in the case where the patient does not have insurance, the payer may be the government, since the prescription drugs may be provided to the patient by Medicaid. Insurance companies have been exerting pressure on pharmaceutical companies to reduce the cost of drugs through contracting and rebate programs. Payers, whether private or government have increasing influence on what physicians can and cannot prescribe to ensure that patients are able to afford treatment. Payers may affect the treatment choice by stipulating the drugs which will be covered by a particular insurance plan. The insurance company of the patient may stipulate a list of prescription medications that will be fully covered under the insurance plan. For example, the patient may select the treatment choice that includes the drug that is fully covered by the insurance instead of a treatment choice that includes a drug that may only by partially covered or not covered at all by the insurance plan. In some examples, patients covered by Medicaid are limited to the generic version of a pharmaceutical drug.

Health care reform may affect treatment choice. A change in the structure of healthcare may affect several actors in the determination of patient treatment choice. For example, more and more patients are being covered by ACOs. The introduction of the ACO concept changed the structure of health care and may have an impact on the determination of treatment choice of prescribers. For example, the Patient Protection and Affordable Care Act (PPACA) have expanded health care coverage to millions, who were previously uninsured. This reform of health care has increased the pressure on the health care industry to reduce the cost of health care. Growing payer influence 116 may also affect treatment choice selected by prescribers. Payers, such as insurance companies and in the case of patients on Medicaid, the government, specify a list of prescription drugs that will be covered by different heath care plans. The influence of the insurance companies may grow increasingly as insurance companies decrease the selection of prescription drugs that may be covered by ones' health care plan. Both government and private payers have an effect on treatment choice by pressuring physicians to prescribe affordable treatment choices.

A pharmaceutical company 208 may be the manufacturer and supplier of a pharmaceutical drug. Pharmaceutical companies may have a large impact on the selection of treatment choice. Pharmaceutical companies, in the past, have focused sales and marketing tactics solely on physicians and may even provide physicians with free samples to promote the use of a particular drug. Extensive marketing of a product by a pharmaceutical company to physicians may lead the physician to be persuaded by the sales tactics. Additionally, the introduction of a variety of new promotional channels into the marketing world has led to challenges within the marketing strategies of pharmaceutical companies. For example, the introduction of social media has allowed pharmaceutical companies with smaller marketing budgets to advertise pharmaceutical products for far less than other traditional marketing strategies.

Integrated Delivery Networks (IDNs) 210 may also affect the treatment choice for a patient. As mentioned above, an IDN is a network of facilities and providers that work together to offer a continuum of care to a specific geographic area or market. An IDN is a type of managed care organization and there are many different structures to an IDN. An IDN may be an organization that provides comprehensive health care to a voluntarily enrolled population at a predetermined price. In this case there is a direct contract between the physicians and the hospitals. The providers within the IDN offer discounted rates to members within the IDN. There are different types of IDNs and the structure of each different type of IDN is slightly different. For example in a staff model HMO, the physicians practice within HMO owned facilities and only see HMO enrollees, also the pharmacy services are through an in house facility. In this example, the HMO would have a large impact on the treatment choice selected by the physician since treatment choice would most likely be a product provided by the internal pharmacy services. In the United States, the government has many state laws that are meant to promote the development of IDNs to ensure the quality of care delivered to patients. This promotion of the development of IDNs has led to an increase in the number of IDNs across the nation exceeds 1200. IDNS have implemented strict treatment protocols that set strict guidelines to the physicians within an IDN on which drugs and treatments are preferred for which conditions. The IDNs may also require evidence of the effectiveness of a specific drug and the overall cost effectiveness before the drug may be approved to be prescribed to patients within the IDN.

Prescribers 212 are generally the physicians that prescribe pharmaceutical drugs to a patient. Prescribers may be influenced by all the other stakeholders, such as, patients, payers, IDNs, and pharmaceutical companies, when determining a treatment choice. As indicated above, pharmaceutical companies target physicians with their marketing and sales tactics for selling products. The pharmaceutical company may even provide free samples to physicians. The pharmaceutical company may require the prescriber tracks the number of distributed free samples and the number of patients that use the prescribed drug after receiving a free sample. Tracking free samples may include, the prescriber providing the patient with a voucher card that the patient may use to register online to receive the free sample from a pharmacy. In some cases, IDNs uphold strict restrictions that restrict pharmaceutical companies from even providing free samples to physicians within an IDN. In some cases, IDNs may also restrict or outright ban the entrance of pharmaceutical representatives to their facilities.

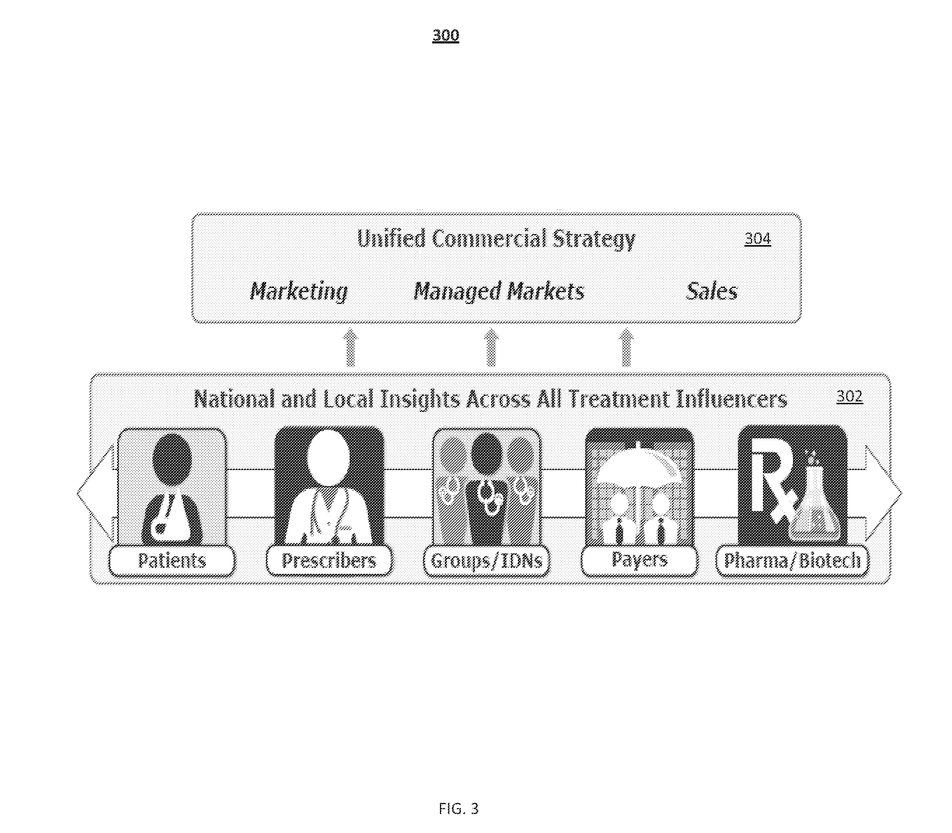

FIG. 3 illustrates an example 300 for determining a unified commercial strategy 304, for a pharmaceutical company by the analytical infrastructure. Information received by the analytical infrastructure from patients, prescribers, IDNs, payers and pharmaceutical companies can be used to derive a unified commercial strategy that specifies budget allocations for commercial resources such as marketing, managed markets and sales. Data received from the patient may include information provided by the patient to the patient's healthcare provider. For example, the information may include demographic information (gender, location, job title etc.). The data about the patient received from the prescriber may be sanitized patient data, therefore the patient's identity remains anonymous. Patient data may also include information about the patient's insurance company. The information may include the name of the patient's insurance company, the type of coverage the patient may have. Information about a patient may also be received from the retail pharmacy that fulfills a prescription for the patient.

The data received from the prescriber may include a prescriber identifier and a network identifier. The prescribe identifier may be an identifier associated with a physician or nurse practitioner writing a prescription. The network identify may identify the IDN that the prescriber may be a member. Prescriber information may also include information on the prescriber's prescription history. This information may include the total number of prescriptions written by the prescriber, and the number of prescriptions written for a particular drug. The prescriber information may be received from prescribers within a specific geographic location or may be information received from prescribers nationally.

The information received from an IDN may include prescription information from the physicians within the network. The IDN may also provide information about the patients treated within the network. The information may include sanitized patient information, so that the patient remains anonymous, the condition the patient is treated for, and the pharmaceutical drug prescriptions provided to the patient by health care providers within the network. The IDN may also provide patient payment information. This information may include the type of payment the patient used to cover the received health care services. For example the information may include if the patient paid by cash, if the patient used insurance and paid co-pay or if the user was covered by Medicaid.

A payer may be the insurance company that covers the patient, or in the case where the patient does not have insurance, the payer may be the government, where the patient is covered by Medicaid. The payer may in some cases be the patient, where the patient purchases prescription drugs without insurance coverage. Information received from the insurance companies may include the names of the pharmaceutical products covered by the company. The information may include information about prescription drugs which are used to treat popular conditions and the prescription drug that is covered by the insurance company. For example, the information may include Lipitor as the pharmaceutical drug covered by the insurance company for the treatment of cardiovascular disease. The payers information may include information received from insurance companies within a specific geographic location or may include received from insurance companies nationwide.

The information from the pharmaceutical company may include the marketing sales information for the marketing of a specific pharmaceutical product. For example, the information may include the total number of free samples of a Lipitor that were distributed to physicians. The information may also include information on the revenue spent on the marketing of a particular product, the total number of sales of the product, the revenue spent on door to door sales of the product etc. The information may further include the specific prescribers within an IDN that received free samples or coupons for a product. The pharmaceutical marketing tactics information may include marketing information of a specific product in a specific geographic location or may include marketing information of a specific product nationwide.

The computing systems of the analytical infrastructure accesses the information received from all the stakeholders that may have an influence on the selected treatment choice. The analytical infrastructure may use the information to calculate an influence factor for the treatment choice influences. In some implementations, the analytical infrastructure may weigh each of the individual elements ratings associated with the information received from patients, prescribers, groups (IDNs), payers and pharmaceutical companies, and apply an equation to calculate an influence factor for each element. The influence factor calculated by the statistical analysis module may be used by the analytical infrastructure to determine the influence of patients, prescribers, groups (IDNs), payers and pharmaceutical companies to treatment choice. In some implementations, the analytical infrastructure module may use one or more statistical models to quantify the influence patients, prescribers, groups (IDNs), payers and pharmaceutical companies on treatment choice.

The analytical infrastructure may use the information and the calculated influence factors to determine the relative influence of the patient, prescriber, groups (IDNs), payers and pharmaceutical company. The analytical infrastructure may use the marketing, sales and payer data of a product provided by the pharmaceutical company to calculate a performance indicator. In some implementations, the analytical infrastructure may use one or more statistical models to generate a performance indicator for a commercial strategy based on the sales of the pharmaceutical product. For example, door to door sales of a product may receive a high performance indicator if the physicians that were visited in the door to door visits prescribed the product and contributed considerably to the sales revenue of the product.

The analytical infrastructure generates a unified commercial strategy report based on the marketing sales data and the calculated performance indicator of marketing strategies. In some implementations, the analytical infrastructure may generate a unified commercial strategy for a pharmaceutical company based on one pharmaceutical product in a specific geographical location. In other implementations, the unified commercial strategy is based on a nationwide location. The analytical infrastructure has the ability of identifying if allocating funds for the promotion of a particular pharmaceutical product is supported by the IDNs within the area. For example, the analytical infrastructure may, based on a selected geographical location determine the marketshare of one more IDNs within a geographic location and evaluate the total revenue spent in promoting the pharmaceutical product in the area and compare the data to determine if the budget allocated to the geographical location is justified, that is if the revenue spent leads to profitable returns.

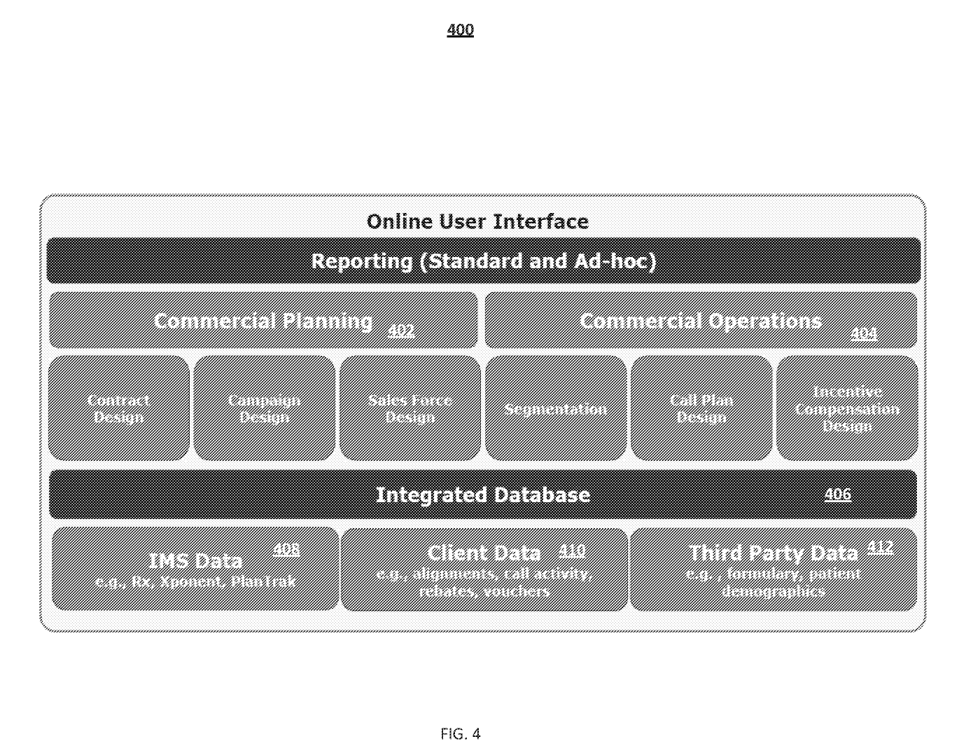

FIG. 4 is an example of an online management tool for the analytical infrastructure. The online management tool may be implemented on a web page that allows the users to view data received from the various stakeholders. The online management too may allow the user with access to commands that allow the user to manage and manipulate marketing sales information. The user interface shows a commercial planning tab 402 and a commercial operations tab 404. These tabs may be used by most users and includes further tab selections such as the contract design, the campaign design, the sales force design, segmentation, call plan design, and incentive compensation design.

The user interface also includes an Integrated Database tab 406. Below this tab the user may select the IMS data tab 408, the client data tab 410 or the third party data tab 412. In some implementations, the user may be a user at a pharmaceutical company. In some implementations, the Integrated Database may include solely IMS data. In some implementations, the user may be a user at a pharmaceutical company. The user at the pharmaceutical company may select the IMS data tab 408 to view the reported information stored at the analytical infrastructure on the pharmaceutical products manufactured by the pharmaceutical company. The IMS data may include the number of prescriptions written for a particular pharmaceutical product, the number of physicians that prescribed the pharmaceutical product and the information may include the Integrated Delivery Network that the prescriber may belong to. The client data tab 410 may include data on the number of rebates have been provided for a particular drug manufactured by the pharmaceutical company. The client data tab may also include data on the number of vouchers have been provided for the particular drug. The third party data tab 412 may include data on patient demographics, for example the age or sex of a patient that was prescribed a particular pharmaceutical product.

The user interface includes a tab for commercial planning 402. A user at the pharmaceutical company may select the commercial planning tab and generate the three tabs below commercial planning as illustrated in FIG. 4.

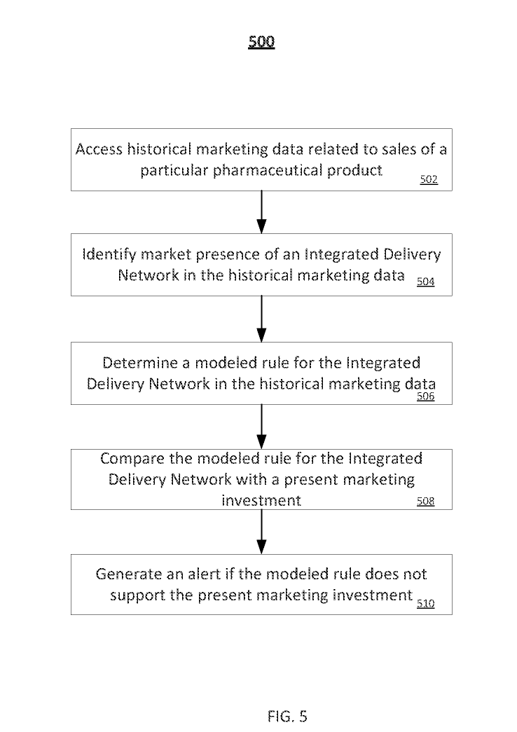

FIG. 5 is a flow chart of a process by which the analytical infrastructure uses accessed marketing data.

The analytical infrastructure accesses historical marketing data related to sales of a particular pharmaceutical product (502). The computing systems at the analytical infrastructure may access commercial information from the pharmaceutical company that manufactures and distributes a particular product. The commercial information may include information on the number of free samples of the product distributed to physicians and the number of coupons or vouchers for the product distributed to physicians. The information reported to the analytical infrastructure may also include the revenue spent on calling physicians to market product and the revenue spend on hosting online broadcast marketing the product to physicians. The pharmaceutical company may report all the marketing data related to a product to the analytical infrastructure system periodically, for example the pharmaceutical company may report data once a week, or the pharmaceutical company may report once a month. In some implementations, the computing systems at the analytical infrastructure may requests marketing data from the pharmaceutical company for a specified time period. The analytical infrastructure may request information on marketing a product in a specified geographic location. The computing systems at the analytical infrastructure may save the marketing data related to the sales of the product.

The analytical infrastructure identifies market presence of an Integrated Delivery Network in the historical market data (504). The data reported from the pharmaceutical company may include one a physician identifier or network identifier. The physician identifier may identify the physician that was targeted by the marketing strategies of the product. The physician identifier may be used by the analytical infrastructure to identify the Integrated Delivery Network the physician is related to, if any. The information may further include a network identifier, the network identifier identifies the Integrated Delivery Network that the marketing strategies were targeted to. One or more Integrated Delivery Networks may be identified in the accessed historical marketing data.

The analytical infrastructure determines a modeled rule for the Integrated Delivery Network in the historical marketing data (506). The data processing module 118 at the analytical infrastructure computing system processes the accessed historical marketing data. In processing the data, the data processing module may filter and/or mine the marketing data for specific information. The data processing module may filter/or mine the marketing data for data on a specific pharmaceutical product. The data processing module may filter/or mine marketing information for data from a specific Integrated Delivery Network. The data processing module may use the processed data for a specific pharmaceutical product at a specific Integrated Delivery Network to determine a module rule for the Integrated Delivery Network.

The analytical infrastructure compares the modeled rule for the Integrated Delivery Network with a present marketing investment (508). The data processing module at the computing system of the analytical infrastructure compares the modeled rule generated for the identified Integrated Delivery Network with a generated present marketing investment. The present marketing investment may be generated by the data processing model. In some implementations, the present marketing investment is generated based on marketing data received from one or more pharmaceutical companies marketing one or more pharmaceutical products. The present marketing investment may be generated using marketing information from pharmaceutical companies nationwide, or the present marketing investment may be generated using information received from pharmaceutical companies worldwide. For example, the present sales investment may identify a budget for various sales strategies, for example a budget for samples of pharmaceutical products, a budget for door to door sales persons promoting a product etc. The data processing module compares the particular budget allocations of the modeled rule for the IDN and the present sales investment.

The analytical infrastructure generates an alert if the modeled rule does not support the present marketing investment (510). The data processing module at the computing system of the analytical infrastructure compares the values for the revenue spent on the marketing strategies within the modeled rule for the Integrated Delivery Network, with the budget allocations for the present marketing investment. An alert is generated if the modeled rule and the present marketing investment are not a match.

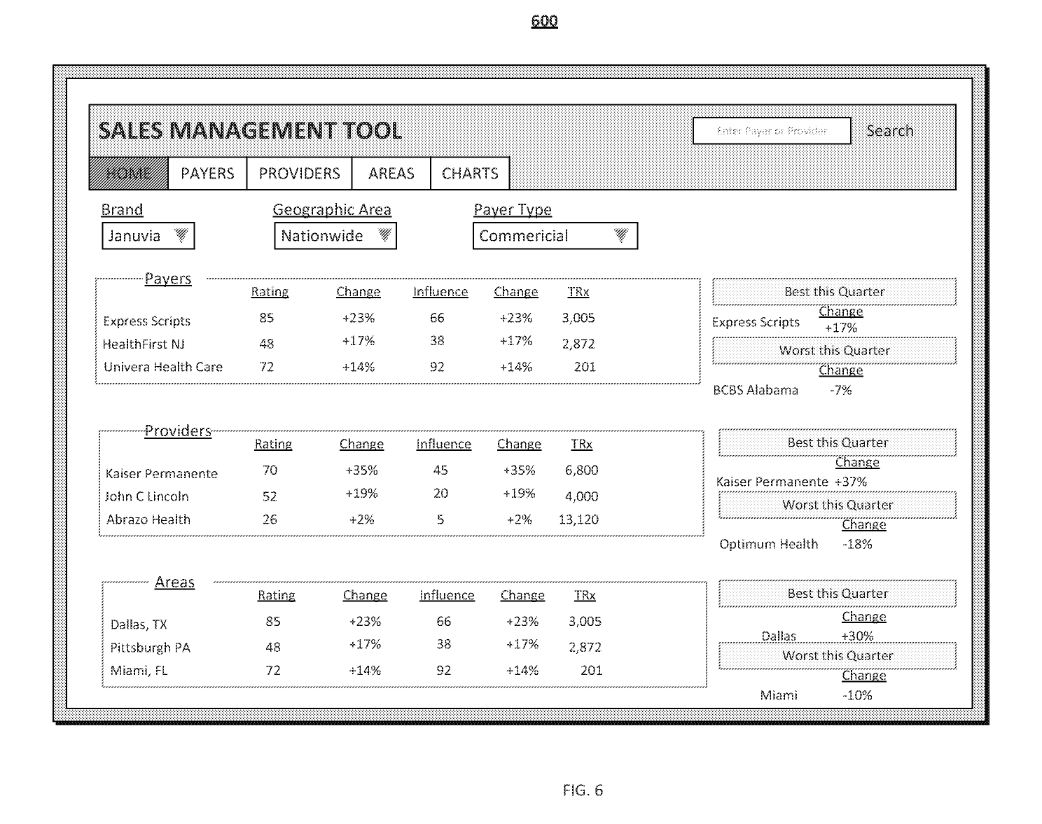

FIG. 6 illustrates an example user interface 600 that illustrates the homepage of a web application for a sales management tool. Interface 600 may be displayed when a user, at a pharmaceutical company logs into a secure connection with the sales management tool system. The user may log into the sales management tool system by providing a user specific user name and password. The sales management tool system then generates the home page, as illustrated in FIG. 6. The home page is specific to individual users of the sales management tool system, that is, the homepage generated is specific to pharmaceutical company. In some implementations, the user may have the option to customize the information displayed on the homepage. In these implementations, the home page may include a “Customize Page” tab displayed on the home page.

The home page may include one or more drop down tabs. The drop down tabs may be used to specify a brand, a geographical area, and payer type. A brand may be a particular pharmaceutical drug manufactured/distributed by the pharmaceutical company. The geographical area may be specified by state, county or zip code. For the example illustrated in FIG. 6, historical data is displayed for the selected brand Januvia, within the nationwide geographic area. In some implementations, the home page may include a “Watch list” created by the user. The watch list may include the top ranking payers, providers and areas for the particular pharmaceutical drug selected. The homepage may also display the best and worst performers in each category of payers, providers and areas based on the particular drug selected. In some implementations, the historical data displayed in the watch list and the best and worst performer lists may not be specific to one pharmaceutical product. In these implementations, the historical data displayed on the homepage could be data regarding one or more products manufactured or produced by the pharmaceutical company. The home page allows the user to get an overview of the historical data obtained from the various stakeholders that affect the selection of treatment choice.

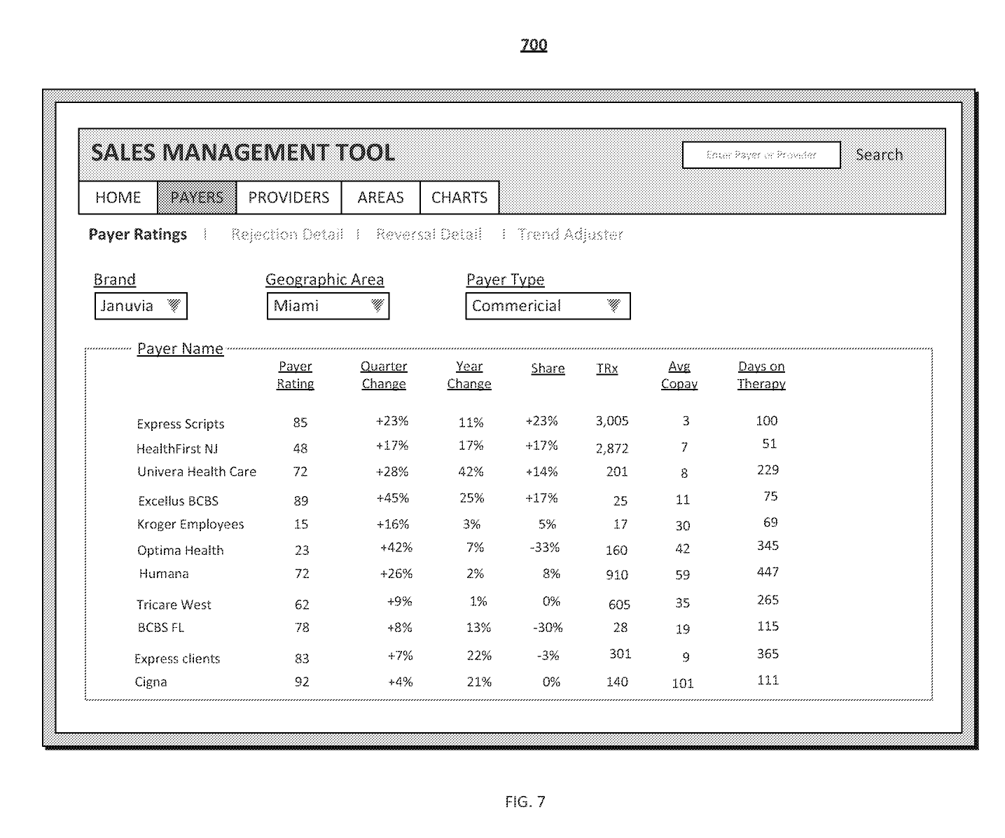

FIG. 7 illustrates an example user interface 700 that shows the payer ratings tab of a web application for a sales management tool. FIG. 7 may be displayed when the user selects the payer tab on the task pane and then selects the payer ratings sub tab.

The payer ratings page may include the same one or more drop down tabs displayed on the homepage. The drop down tabs may be used to specify a brand, a geographical area and payer type to display historical data for. For the example illustrated in FIG. 7, the historical data displayed is for the brand Januvia in the Miami area. The data displayed on the payer ratings page, as depicted by FIG. 7, includes the list of the one or more payers in the Miami area. For each payer listed, the data displayed may include one or more data categories. As illustrated in FIG. 7, the data may include the payer rating, the quarter change, the year change, the share, the total prescription, the average copay and days on therapy. The data displayed may be computed from the prescription data, insurance data, pharmaceutical purchase data and longitudinal prescription data received by the computing systems of the analytical infrastructure system. The payer rating may be calculated based on all or some of the data collected for a specific data and is a direct measure of performance of the payer. For example, that data about payer Express Scripts includes the payer rating of 85 with an increase this quarter of 23%, an annual change of 11%, a marketshare of 23%, total number of prescriptions 3005, the average no of copays 3, and the average number of days patients using the selected drug Januvia remained on therapy 100. The detailed data displayed on user interface 700 for each payer in the geographical area selected allows the pharmaceutical company user to view the performance of a drug on a granular level. In some other implementations, the data may include the rejection rate, reversed rate and provider rating.

These metrics may be used to demonstrate efficacy of sales representatives with physicians and within IDNs. For example, the data shows that for BCBS FL the total number of prescriptions for Januvia that was sold in the Miami area for the period is 28. The data may also include the number of sales representatives for marketing Januvia in the Miami area, for example, the number of sales representatives is 15. Based on the data shown and the number of sales representatives used, it can be concluded by the pharmaceutical company using the sales management tool that the number of sales representatives is not proportional to the sale of the drug, and that marketing efforts should be redirected away from sales representatives to increase the number of sales and the marketshare of the product. The data may be used to compare to the use of sales presentations in the same geographical area but by patients supported by a different payer.

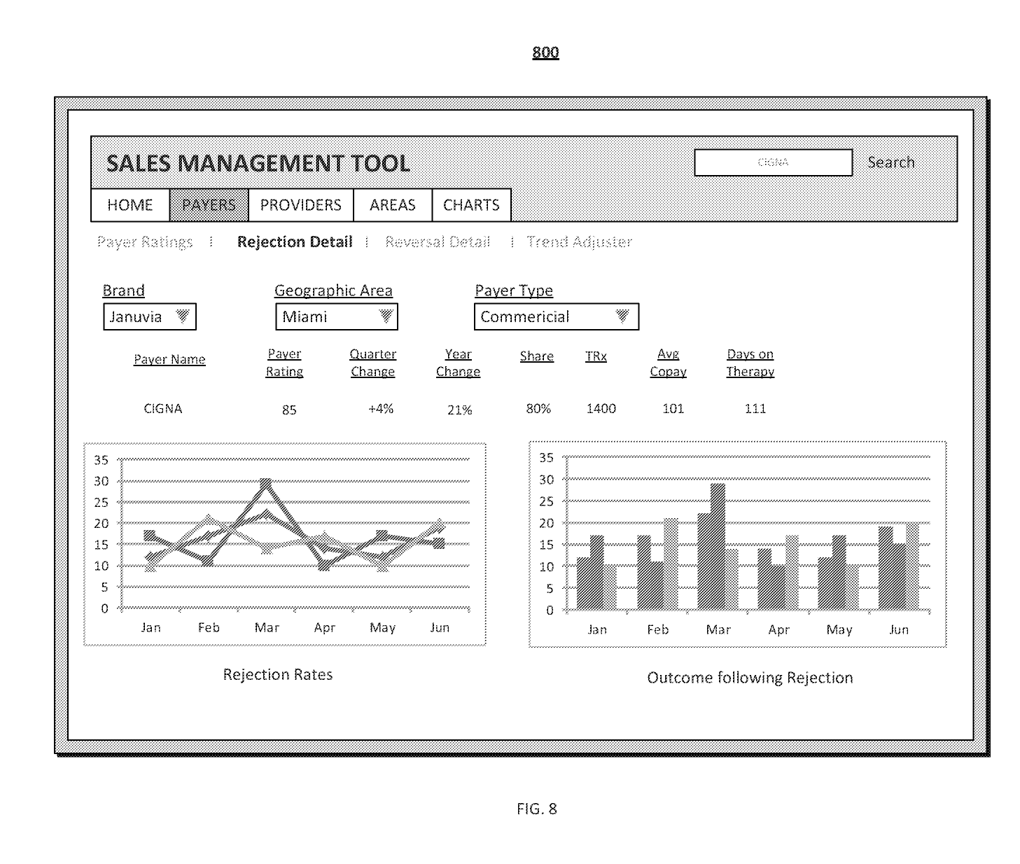

FIG. 8 is an example user interface 800 that illustrates the pay reversal detail tab of a web application for a sales management tool. FIG. 8 may be displayed when the user enters a payer name into the search text box on the homepage and is directed to the payers tab and then further selects the reversal detail tab.

The payer reversal detail page may include the same one or more drop down tabs displayed on the homepage. The drop down tabs may be used to specify a brand, a geographical area and payer type to display reversal details data for. For the example illustrated in FIG. 8, the user entered the payer Cigna and the web application generated a page with the detailed data on Cigna. In some implementations, the data is represented in a table form, and in some implementations the data may be displayed in a chart or graph. The data may also show the impact that Cigna has on a specific geographic location. For the example shown, the data is representative of the reversal detail for the pharmaceutical product Januvia in the Miami area. In some implementations, the user may adjust the rejection rates of the selected payer and the analytical infrastructure of the sales management tool would dynamically populate forecasted values for the gross revenue and net revenue based on the adjusted rejection rates. In these implementations, the sales management tool provides predictive analytical capabilities. The data shows that Cigna has a high marketshare at 80% and the total no of prescriptions sold is 1400. In some implementations, this data may be used for projecting sales data for upcoming periods. In other implementations, for the selected payer, the sales management tool can populate gross revenue and net revenue values. In these implementations, these values may be generated based on the rebate percentage that may be applied by some payers to a specific product. The user may adjust the rebate rate and the sales management tool may dynamically generate gross revenue and net revenue vales based on the selected rebate rate. Pharmaceutical companies can forecast sales profits based on different rebate rates by different payers. In this manner, the sales management tools shows companies the maximum rebate rate that can be supported to still support profits.

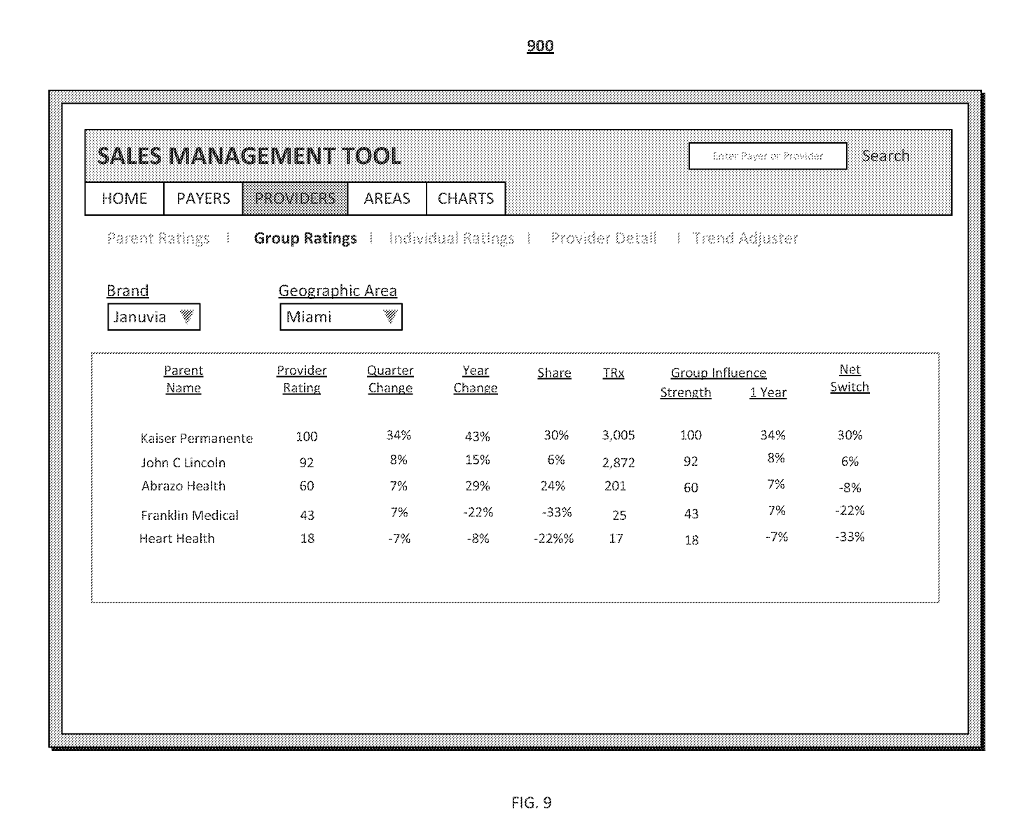

FIG. 9 is an example user interface 900 that shows the group ratings tab of a web application for a sales management tool. FIG. 9 may be displayed when the user selects the providers tab on the task pane and then further selects the group ratings tab. FIG. 9 shows the provider information based on the brand of pharmaceutical selected along with the geographic area selected. The data presented to the user may include the provider rating, the quarter change, the annual change, the share, total prescription, the group influence and net switch for each IDN. The data displayed may be computed from the prescription data, insurance data, pharmaceutical purchase data and longitudinal prescription data received by the computing systems of the analytical infrastructure system. The group ratings page allows the user to compare IDNs performance side by side based on a selected product and the selected geographical location.

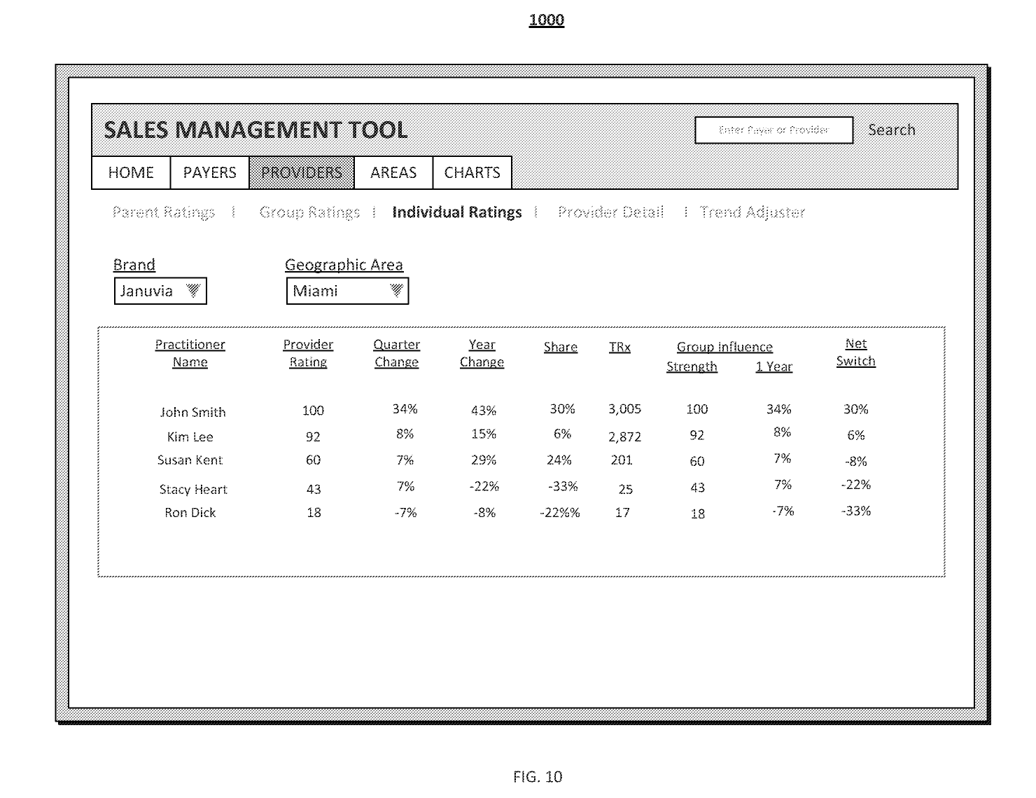

FIG. 10 is an example user interface 1000 that shows the individual ratings tab of a web application for a sales management tool. FIG. 10 may be displayed when the user selects the providers tab and then further selects the individual ratings tab. FIG. 10 shows the data based on the individual practitioner within the IDN. In some implementations, the data for the specific practitioner may be based on a single pharmaceutical prescribed by the practitioner. The data presented to the user may include the provider rating, the quarter change, the annual change, the share and the total prescription for each individual practitioner. The individual ratings page allows the user to compare individual physicians side by side based on a selected product and the selected geographical location.

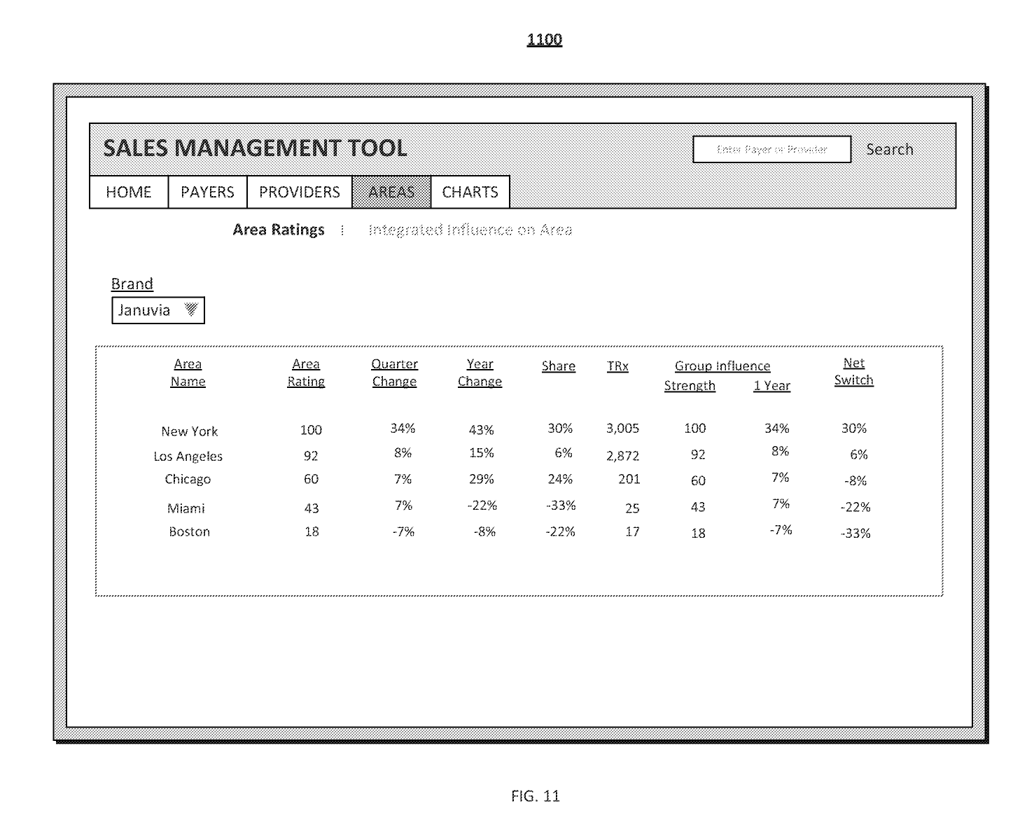

FIG. 11 is an example user interface 1100 that shows the area ratings tab for a sales management tool. FIG. 11 may be displayed when the user selects the areas tab and then further selects the area ratings tab. FIG. 11 shows the data for a specific brand based on geographical areas. The data presented to the user may include the area rating, the quarter change, the annual change, the share and the total prescription based on the geographical area. The user navigating the sales management tool has the ability to filter and view at data based on a variety of different factors. In some implementations, the user is able to evaluate, based on the data shown, the areas where sales representatives should be used to promote the sale of a selected product. For the example illustrated, the total prescriptions for Miami and Boston are both low below 30 for the period, the user may evaluate the data and determine that sales representatives may be useful in these two areas to help increase the product sales. In some implementations, the user may enter a number of sales representatives and the sales management tool may dynamically generate the forecasted share and total prescriptions for the area based on the selected number of representatives.

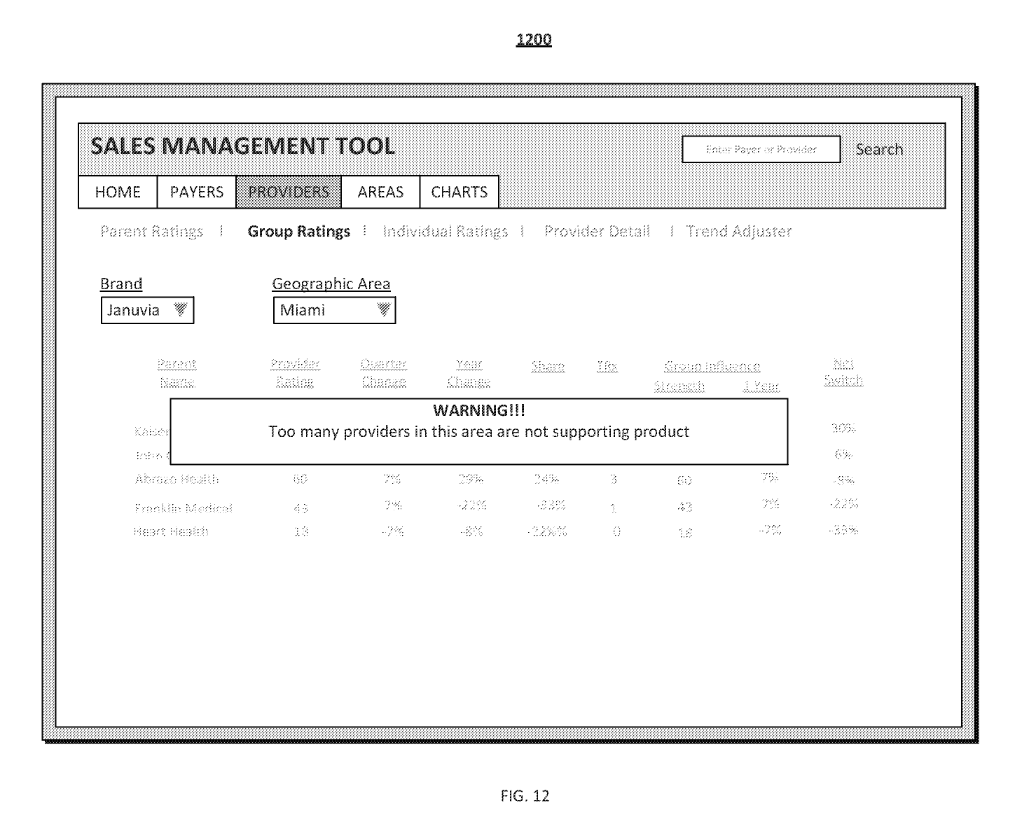

FIG. 12 is an example user interface 1200 that includes a warning message that may be displayed when a user is navigating the sales management tool. The warning message may be displayed if the data for one or more IDNs indicates that the pharmaceutical product selected is not being supported. For example, the error message may be displayed if the marketshare for the selected product, within one or more IDN networks is low. As illustrated in FIG. 12, the marketshare for Franklin Medical and Heart Health both reflect negative marketshare values, indicating that the product is not supported by the prescribers that are members of these IDNs.

In other implementations, a warning message may be displayed if a user enters a rebate rate that is beyond a specified rate, as described in FIG. 8 above, that results in less than a specified level of profit based on the forecasted gross revenue and net revenue values. In other implementations, a warning may be generated that identifies to the user, which IDNs support the product. For example, some pharmaceutical products may not be supported by an IDN, either because the drug is expensive, and/or because the drug does not have a specified degree of therapeutic effectiveness. In these instances, the prescribers within an IDN will not prescribe the product regardless of the marketing tactics. A warning message may be displayed if one or more IDNs selected do not support the selected product. A warning may also be displayed based on the individual prescribers within such identified IDNs.

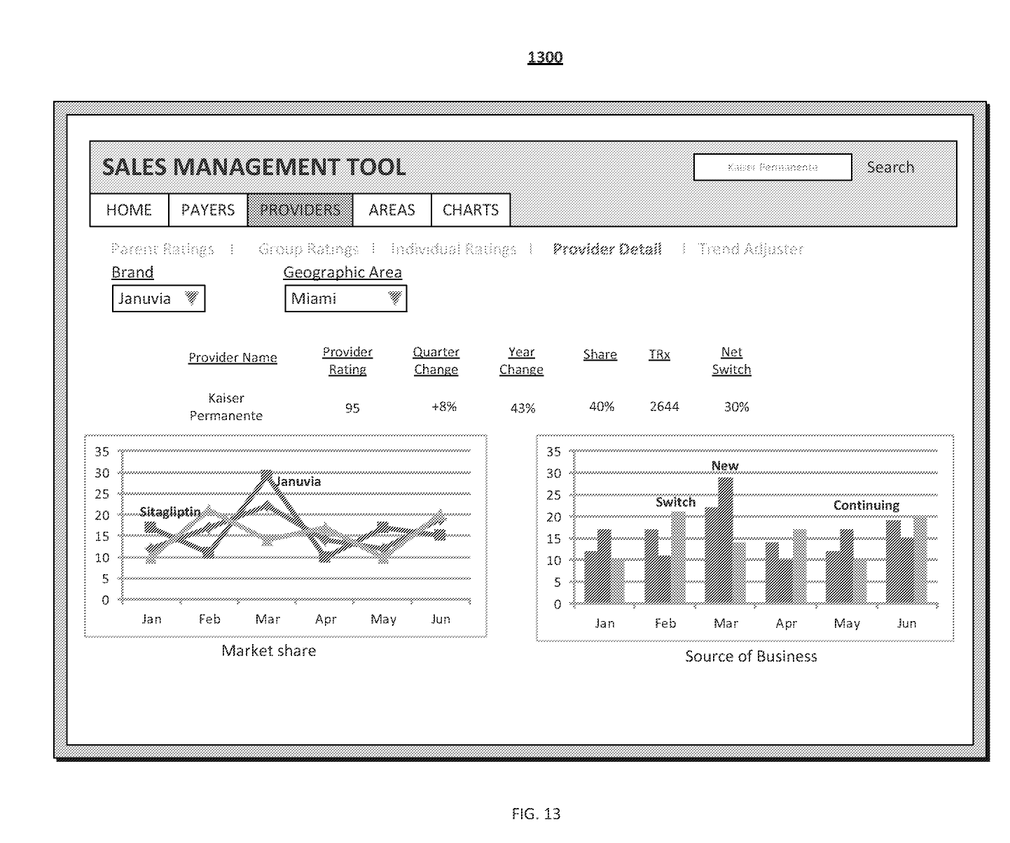

FIG. 13 illustrates an example user interface 1300 that shows the provider's detail tab of a web application for a sales management tool. FIG. 13 may be displayed when a user selects the provider's tab on the task pane and then further selects the provider's detail sub tab.

The provider detail page may include one or more drop down tabs. The drop down tab options may be used to specify a particular brand product and geographic area. The user may also select a particular provider by entering the provider name in the search box. For the example shown in FIG. 13, the user enters Kaiser Permanente in the search text box and the web application generates a page with detailed data on the provider Kaiser Permanente. In some implementations, the data is represented in a table form. In other implementations, the data may be displayed in a chart or graph. As illustrated in FIG. 13 the data displayed represents the brand share data over a period of six months and the source of business for the product Januvia in the Miami area. The data displayed may be determined from the prescription data, insurance data, pharmaceutical purchase data and longitudinal prescription data received by the computing systems of the analytical infrastructure system. In some implementations, the marketshare data may also display marketshare data for competitor products that treat the same condition as the selected brand. For example, the marketshare data may display the marketshare data for the generic version of Januvia, Sitagliptin, over the same time period and for the same geographical area. In some implementations, the marketshare data for the competitor products may not be available for the exact same time period. In these implementations, the computing systems at the analytical infrastructure may use the collected marketshare data to predict a marketshare across the selected time period. In some other implementations, the user can select the time period over which the marketshare information should be displayed. For example, the user may select to view the marketshare data for a particular product over a specified week in a January.

In some implementations, the marketshare data may be displayed for one or more IDNs. In these implementations, the user may select one or more IDNs within a specified geographic location and the generated graphical display of the data may include the marketshare data for the products within the one or more IDNs. In some other implementations, the marketshare data may include nationwide data for one or more IDNs. In these implementations, the data may be used to compare the marketshare data for the IDNs across the nation to identify the IDN with the highest and lowest marketshares of the specified products. For example, the data may include marketshare data for Cigna across the nation.

The data displayed on the provider's detail page may also include source of business data. The source of business data identifies the tag identifiers associated with prescription data accessed by the analytical infrastructure. For example, tag identifiers may be associated with prescription data to identify if the prescription is considered a new prescription, a switch prescription, a reinitiating prescription, or a continuing prescription. A prescription may be tagged as a new prescription if the prescription data indicates that the patient has never been prescribed the specific drug in the past. In some implementations, a prescription may be tagged new if the patient has not been prescribed the specific drug within six years. In other implementations, the prescription may be tagged new if the patient has not been prescribed the specific drug within another specified time period. A prescription may be tagged as a switch prescription if the prescription data indicates that the patient was previously on a different prescription drug and is now being prescribed a different drug to treat the same condition. In some implementations, a prescription may be tagged as a switch prescription if the patient has been prescribed another drug to treat the same condition within one year of the prescription. In some other implementations, a prescription may be tagged as a switch prescription if the patient has been prescribed another drug to treat the same condition within six months of the prescription. A prescription may be tagged as a reinitiating prescription if the prescription data indicates that the patient had been prescribed the drug in the past but had not been prescribed the drug recently. In some implementations, a prescription may be tagged as reinitiating if the patient had been prescribed the drug within five years but had not been prescribed the drug in the past year. A prescription may be tagged as a continuing prescription if the prescription data indicates that the patient has been prescribed the drug repetitively.

In some implementations, the source of business data may be displayed for the same period as specified for the marketshare data. In other implementations, the source of business data may be displayed for a time period that is different that the time period specified for the marketshare data. The source of business data may be an important indicator for the performance level of the specified product. The user may specify a time period to display the source of business data.

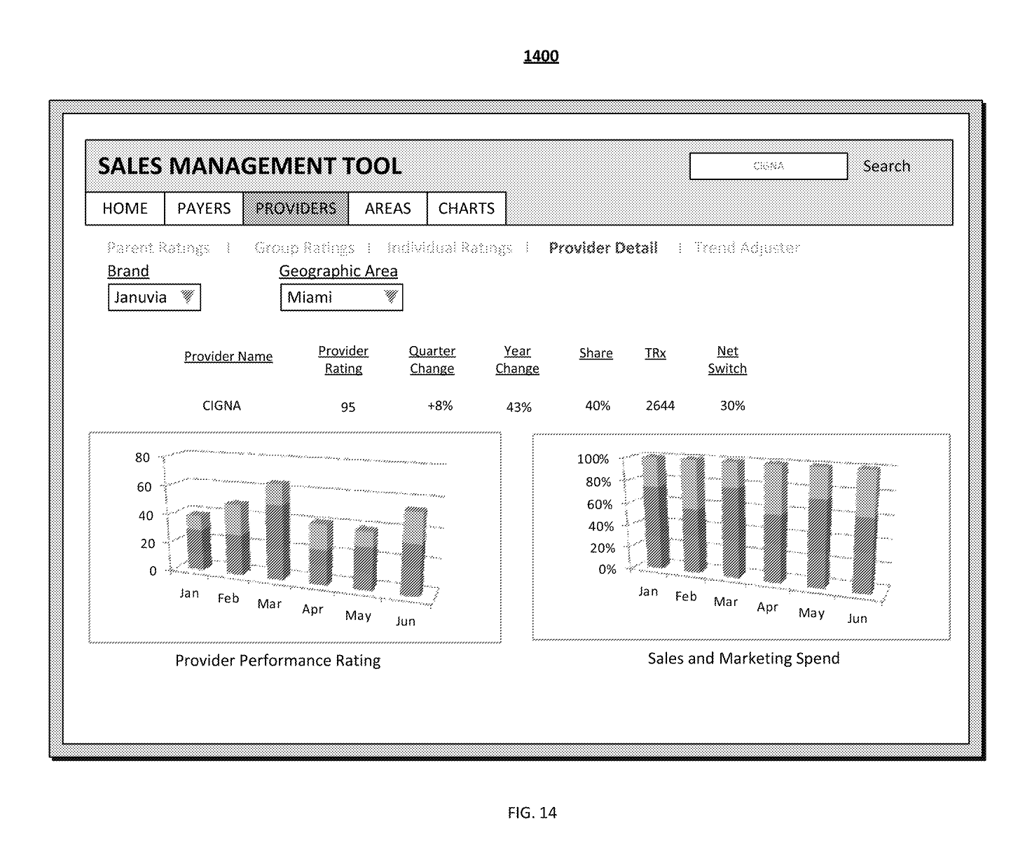

FIG. 14 illustrates an example user interface 1400 that illustrates the providers detail tab of a web application for a sales management tool. FIG. 14 may be displayed when a user selects the provider's tab on the task pane and then selects the provider's detail sub tab.

The provider's detail page may include one or more drop down tab options. The drop down tabs may be used to specify a particular brand product and geographic area. The user may also select a particular provider by entering the provider name in the search box. For the example shown in FIG. 14, the user enters Cigna in the search text box and the web application generates a page with detailed data on the provider Cigna. In some implementations, the data is represented in a table form. In other implementations, the data may be displayed in a chart or graph. As illustrated in FIG. 14 the data displayed represents the provider performance rating over a period of six months and the sales and marketing spend for the product Januvia in the Miami area. The data displayed may be determined from the prescription data, insurance data, pharmaceutical purchase data and longitudinal prescription data received by the computing systems of the analytical infrastructure system. In some implementations, the provider performance rating data may display the performance rating of one or more IDNs within a specified geographic area. In these implementations, the ratings of providers can be compared side by side to determine which provider has the highest performance rating based on a specific product for a given period of time. For example, the performance ratings of Cigna and Kaiser Permanente can be compared side by side for a specific six month period.

The provider detail may also include sales and marketing spend data for a specified period of time. In some implementations, the sales and marketing spend data may be displayed for the product specified in the brand drop down tab. In some other implementations, the sales and marketing spend data may be displayed for the specified product as well as the sales and marketing spend data for competitor products used to treat the same condition. In these implementations, the sales and marketing spend data may be used to compare the effectiveness of commercial techniques for a particular product.

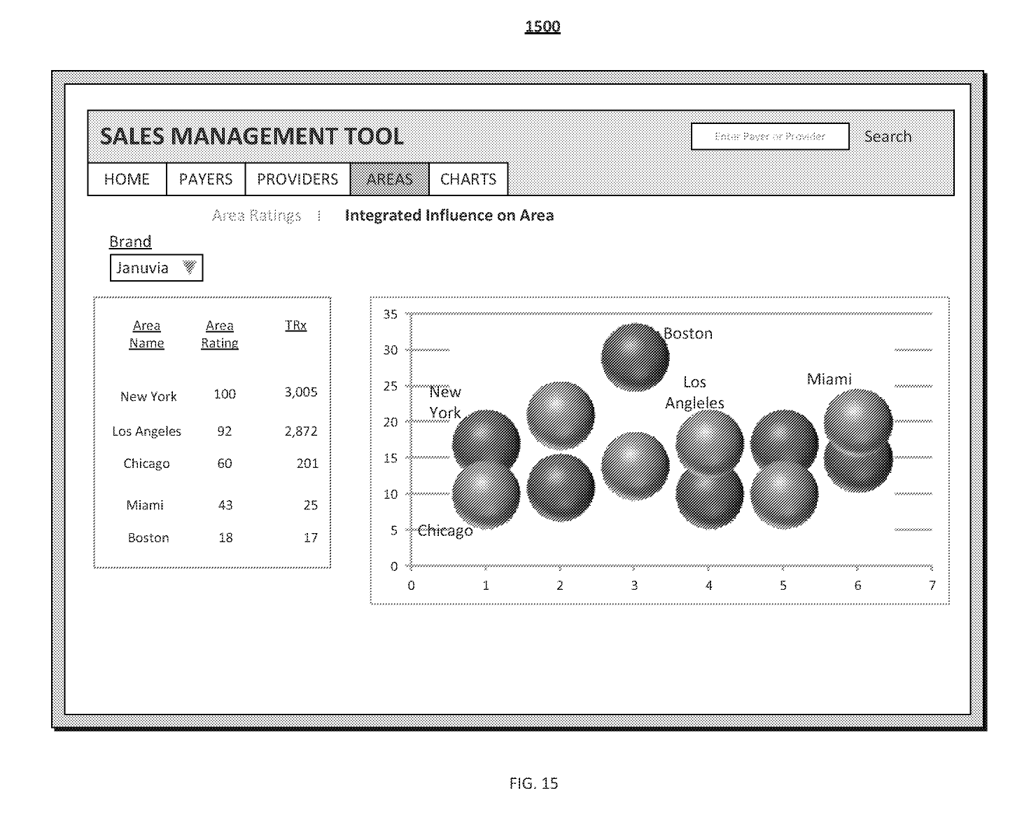

FIG. 15 illustrates an example user interface 1500 that displays the integrated influence area tab of a web application for a sales management tool. FIG. 15 may be displayed when a user selects the area tab on the task pane and then selects the integrated influence on area sub tab.

The integrated influence on area page may include one or more drop down tab options. The drop down tab may be used to specify a particular brand product. The user may also select a particular area by entering the zip code of the area of interest or by entering the city name. For the example illustrated in FIG. 15, the user selects Januvia from the brand drop down box and the web application generates a page with detailed data on the selected product across the nation. In some implementations, the data is represented in a table form. In other implementations, the data may be displayed in a chart or graph. The data displayed may be determined from the prescription data, insurance data, pharmaceutical purchase data and longitudinal prescription data received by the computing systems of the analytical infrastructure system. In some implementations, the user may select the areas of interest from the list of areas that may be covered by a particular IDN. For example, Washington D.C., and North Carolina may be selected from the list of areas covered by Blue Cross Blue Shield. The integrated influence on area page allows a user to compare area ratings side by side, based on a selected product. In some implementations, area influence can be compared across IDNs for example the area rating for Boston by Blue Cross Blue shield may be compared to the area rating for Boston by Cigna.

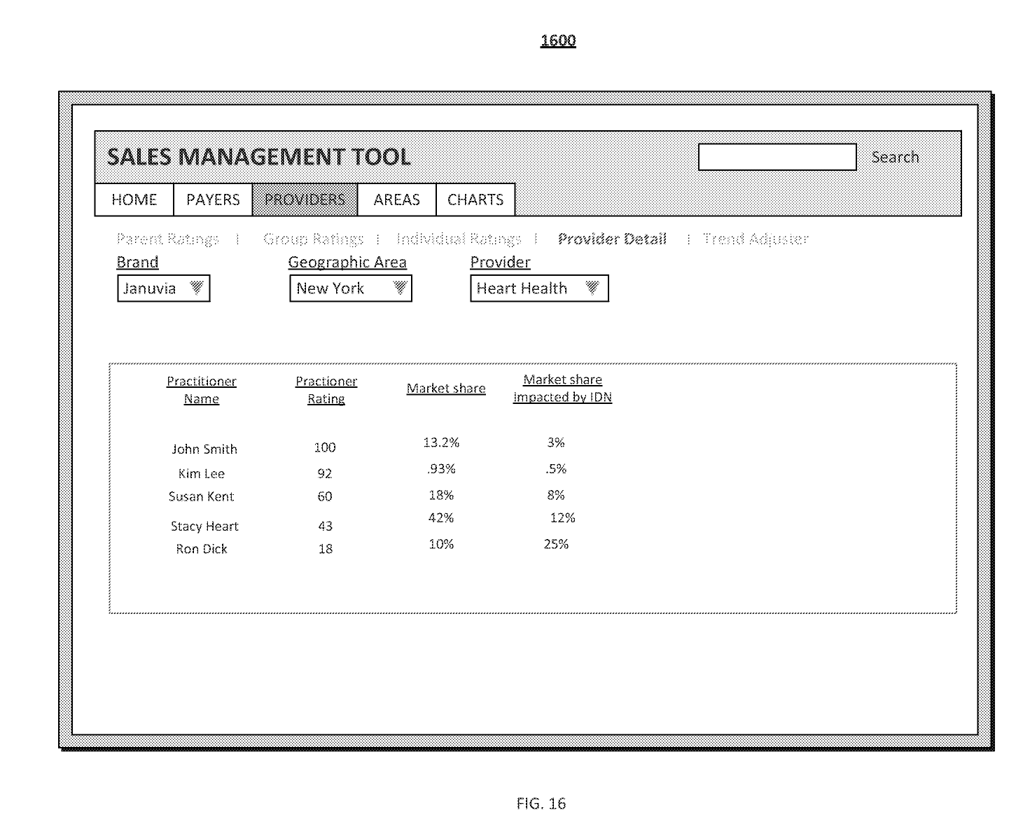

FIG. 16 illustrates an example user interface 1600 that displays the provider detail tab of a web application for a sales management tool. FIG. 16 may be displayed when a user selects the provider's tab on the task pane and then selects the provider's detail sub tab.

The provider's detail page may include one or more drop down tab options. The drop down tabs may be used to specify a particular brand product and geographic area. The user may also select a particular provider by entering the provider name in the search box. For the example shown in FIG. 16, the user selects Heart Health, an IDN, from the drop down provider tab and selects Januvia from the drop down brand tab and specifies the New York area. The web application generates a page with detailed data on the provider, Heart Health, in the New York area. As illustrated in FIG. 16 the data displayed represents the practitioner detail information. The data may include the practitioner name, practitioner rating, marketshare and marketshare impacted by IDN data. The data displayed may be determined from the prescription data, insurance data, pharmaceutical purchase data and longitudinal prescription data received by the computing systems of the analytical infrastructure system. The data may include the marketshare for the particular product contributed by each practitioner. For the example shown in FIG. 16, the marketshare for John Smith in the New York area is 13.2%. In some implementations, data displayed may include the prescribing data related to one or more practitioners within the IDN. For example, the data may include the number of new prescriptions prescribed by John Smith within a designated time period. In some implementations, the user may select a particular prescriber to view the prescribing behavior of the practitioner. In these implementations, the user may enter the name of the practitioner in the search box and the web application generates a page with the detail prescription data on the practitioner.

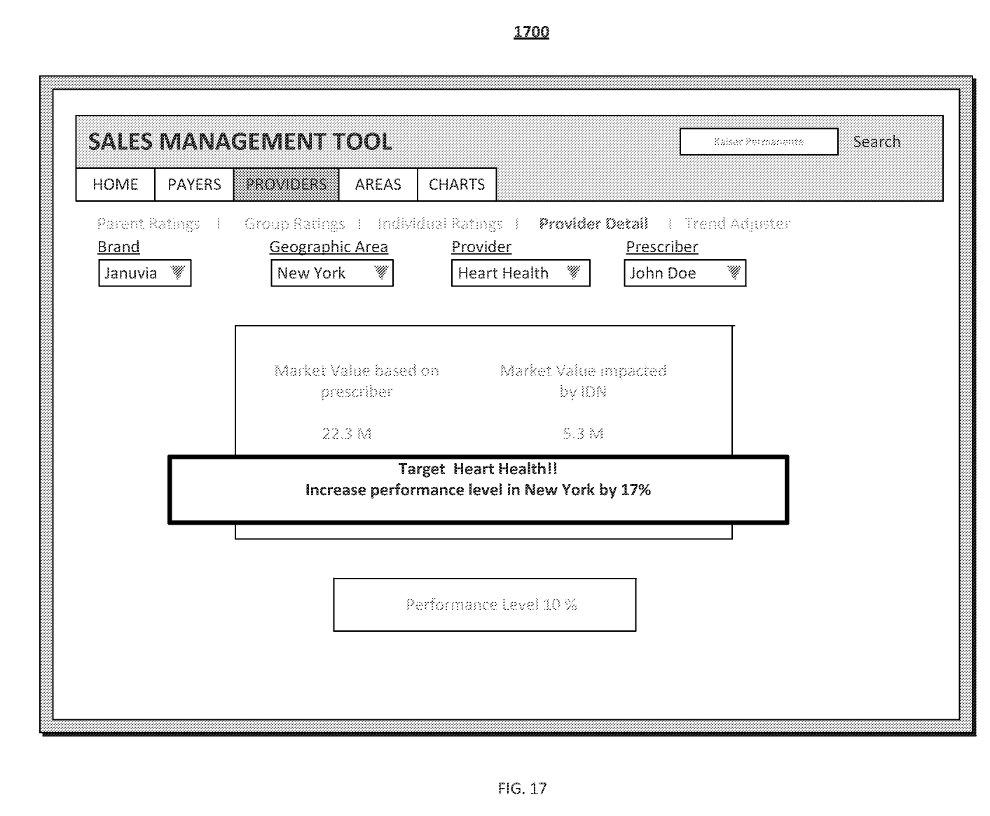

FIG. 17 illustrates an example user interface 1700 that displays an indicator message that may be displayed when a user navigates the sales management tool. The indicator message may be displayed if based on the selected brand and geographic location. The computing systems at the analytical infrastructure identify an IDN that should be targeted. For the example illustrated in FIG. 17, the indicator message may be displayed if Heart Health can lead to an increase in performance level of Januvia within Heart Health. The computing systems at the analytical infrastructure may use data accessed from the prescription data, insurance data, pharmaceutical purchase data and longitudinal prescription data to identify a specific IDN that should be targeted by a pharmaceutical pharmacy that distributes a particular drug. In some implementations, the computing systems at the analytical infrastructure may identify a specific IDN to be targeted if the marketshare of the specified product is below a set threshold. For example, the indicator message may be displayed if the marketshare of a product is below 10 percent. In these examples, a pharmaceutical company may target the specified IDN to increase the number of prescriptions written by physicians within the network. The pharmaceutical company may target the specific IDN to increase the marketshare within the IDN. In some implementations, marketshare for a particular product may be determined based on a specific geographic location. In other implementations, the marketshare for a particular product may be determined based on one or more geographic locations.

In some implementations, the computing systems at the analytical infrastructure may identify a specific IDN to be targeted if the performance level of a specific drug with the IDN may be increased. In these implementations, the coverage provided by an IDN may be categorized by one or more tiers. For example, Heart Health may support three tiers. The coverage of pharmaceutical products under each tier plan may be different based on the preferences of the patient. In some examples, the tier one plan may be the most expensive of the three plans but may cover a highest percentage of most prescription drugs. The tier three plan may, in some examples, be the cheapest of the tier plans but may only cover a small percent of prescription drugs. The performance level of a specific drug may be determined by the computing systems at the analytical infrastructure based on the one or more plans within an IDN. In some implementations, the performance of a specific drug may be higher in one plan within the IDN than another plan within the IDN. For example, the performance level of Lipitor in the tier one plan of Heart Health may be 15% whereas the performance level of Lipitor in the tier three plan is 3%.

In some implementations, an indicator message is displayed if the performance level of a specified drug within an IDN is below a set threshold value, for at least one plan within the IDN. For example, Cisco may be identified as an IDN that should be targeted if the performance level of Flomax is less than 3% for at least one plan within Cisco. In some implementations, an indicator message may be displayed if the specific product is supported by one or more plans within an IDN and an increase in performance level may be probable. For example, if the Lipitor is supported by all the plans within Kaiser Permanente and the performance level of the drug is 20%, the computing systems at the analytical infrastructure may generate an indicator message. The indicator message generated may include a generated increase in performance level that may be possible if the particular IDN is targeted. For example, the indicator message may indicate that a 5% percent increase in performance may be obtained if Kaiser Permanente is targeted.

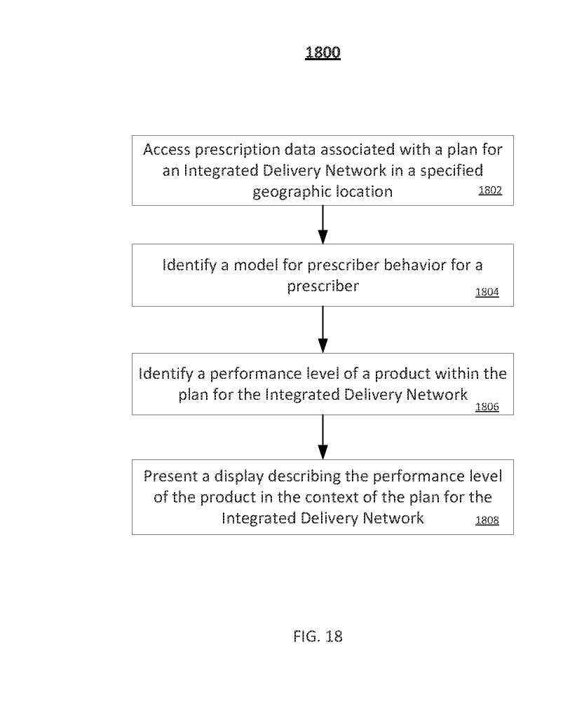

FIG. 18 is a flow chart of a process by which the analytical infrastructure uses accessed prescription data to display the performance level of a product.

The analytical infrastructure accesses prescription data associated with a plan for an Integrated Delivery Network in a specified geographic location (1802). The computing systems at the analytical infrastructure may access the prescription data of patients serviced by the prescribers within an identified IDN. The prescription data may be received by the computing systems at the analytical infrastructure from different sources. In some implementations, the prescription data may be received from the IDNs where the patient received the prescription. In some other implementations, the prescription data may be received from the pharmacy that filled the prescription for the patient. The prescription data accessed by the analytical infrastructure may be categorized by a plan supported by the IDN. In some implementations, an IDN may support members of the network by one or more plans. In these implementations, individuals may be covered by different plans based on the preferences of the individual. For example, an individual may be supported by a tier one plan within the IDN, under this plan the individual may have a copay that may be lower than the copay of an individual supported by a tier three plan. The tier one plan may cover a higher percent of the cost of pharmaceutical drugs and may also cover the cost of more products when compared to a tier two or tier three plans. The prescription data access may be based on prescription data for a specified geographical area. For example, an IDN may support several cities within a country, and the data for each specific geographical location may be considered separately.

The analytical infrastructure identifies a model for prescriber behavior for a prescriber (1804). The computing systems at the analytical infrastructure may use the prescription data to identify the prescriber that prescribed the prescription for the patient. In some implementations, a prescription may be associated with a prescriber identifier that is used to identify the prescriber that distributed the prescription. The prescription data may include a tag identifier that identifies a classification of the prescription. For example, the data may include a new prescription tag if the prescription was prescribed to the patient for the first time and the patient has never received treatment for the condition by another prescription drug. The data may also include a switch prescription tag if the patient switched from one drug to another drug for the treatment of a same condition. The data processing module at the analytical infrastructure computing system processes the accessed prescription data. In processing the prescription data, the data processing module may filter and/or mine the prescription data for a specific prescriber. The data processing module may filter/or mine the marketing data for data on a specific pharmaceutical product. The data processing module may use the processed prescription data for a specific prescriber to determine a model for the prescribers' behavior.

The analytical infrastructure identifies a performance level of a product within the plan for the Integrated Delivery Network (1806). The data processing module at the analytical infrastructure computing systems processes the accessed prescription data. In some implementations, the prescription data may be categorized by the tier plan that the patient is covered by within the IDN. The plan information may be associated with the prescription data by the association with a plan tag identifier. The data processing module may filter/or mine the marketshare data for a particular product to determine a performance level of a specified product within the IDN. For example, the data processing module may use sales data of the particular product within the IDN to evaluate a performance level of the product. In some implementations, the performance level may be directly related to the profit margins for the particular product. In some other implementations, the performance level may be a determined performance level that is calculated by the data processing module using marketing sales data, plan tier data and geographic location of the specific IDN.

The analytical infrastructure presents a display describing the performance level of the product in the context of the plan for the Integrated Delivery Network (1808). The data processing module at the analytical infrastructure computing system presents the determined performance level of the particular product for a particular plan within a specific IDN. In some implementations, the display produced may display the performance level of more than one product within a specific IDN. In some other implementations, the display produced may display the performance level of a particular drug across one or more IDNs.

In some implementations, the payer and the Integrated Delivery Network (IDN) may be a single entity that both provides the medical services to a patient and pays for the medical services received by a patient. In other implementations however, the payer is a separate entity other than the IDN. In these implementations, the IDN also may act as the provider group where the medical services are provided to a patient such that the payer is entity that covers at least a percentage of the cost of the medical services received by a patient. A payer also may be a private insurance company that covers the medical expenses of a patient, or the payer may include the government, for example, when the patient is covered by Medicaid. The IDN or provider group may include a corporate group, or a government-owned facility. In some examples, an IDN may include a non-profit organization, such as an insurance cooperative that is sponsored or assisted by the government.

Insurance plans offered to patients by the payers may feature tiers of coverage or different benefit levels that provide different services and/or areas of coverage between different plans. The coverage of pharmaceutical products and other medical services under each tier plan may be different based on the preferences of the patient. For example, an insurance company may offer one or more insurance plans to patients, and the patient selects the insurance plan that best suits the patient. In some examples, the tier one plan may be the most expensive of the three plans but may cover a highest percentage of most prescription drugs and/or other medical services. The tier three plan may, in some examples, be the cheapest of the tier plans but may only cover a small percent of prescription drugs and/or other medical services.

In some implementations, where the IDN and the payer are not a single entity, the IDN may be designed to have guidelines or protocols that help to incentivize the physician members of the IDN to prescribe a particular product to treat a particular medical condition. An IDN may incentive their physician employees to prescribe a minimum number of prescription brand products. For example, University of Pittsburgh Medical Center may incentivize the physician members to prescribe 50% generic brand drugs. In these ways an IDN may influence the treatment choice used for a patient and in turn influence the market share of a particular pharmaceutical product. The influence of an IDN can be defined as the measure of the entity's ability to cause the physician members to conform and/or practice in a similar manner, with respect to market share. For example, Kaiser Permanente may influence market share of Januvia by incentivizing physician members to prescribe Januvia instead of the generic brand Sitagliptin.

The computing systems at the analytical infrastructure may indicate to the user (e.g., a salesforce manager at a pharmaceutical company) that particular IDNs have been identified as IDNs with a low influence in a specified market place or geographic area. IDNs with a low influence may be targeted by the user. The computing systems at the analytical infrastructure may generate a marketing strategy that identifies the IDNs to target with marketing strategies. In some implementations, the computing systems at the analytical infrastructure may use one or more metrics to determine the change of influence of an IDN that may occur if one or more marketing strategies are implemented.

The favorability of an IDN can be described as the relative level of a performance of the IDN compared to the performance of non-member physicians within the same geographical area. In some implementations, the computing systems at the analytical infrastructure may determine the favorability of an IDN within a postal zip code geographical area, whereas in other implementations the geographical area may be a city. For example, the favorability of Partner Health may be determined for Boston, New York, Miami and other cities. The favorability of payers may indicate a relative level of performance of the payer when compared to the performance of small payer plans within the same geographical area. The computing systems at the analytical infrastructure may identify smaller payer plans as payers who have a small share of prescriptions in a geography. For example, a payer with a 5% or below of the prescriptions in a geography may be identified as a smaller payer. The computing systems at the analytical infrastructure then compares the market share of a particular product within the smaller payer plans to the market share of the specified payer to determine the favorability of the payer.

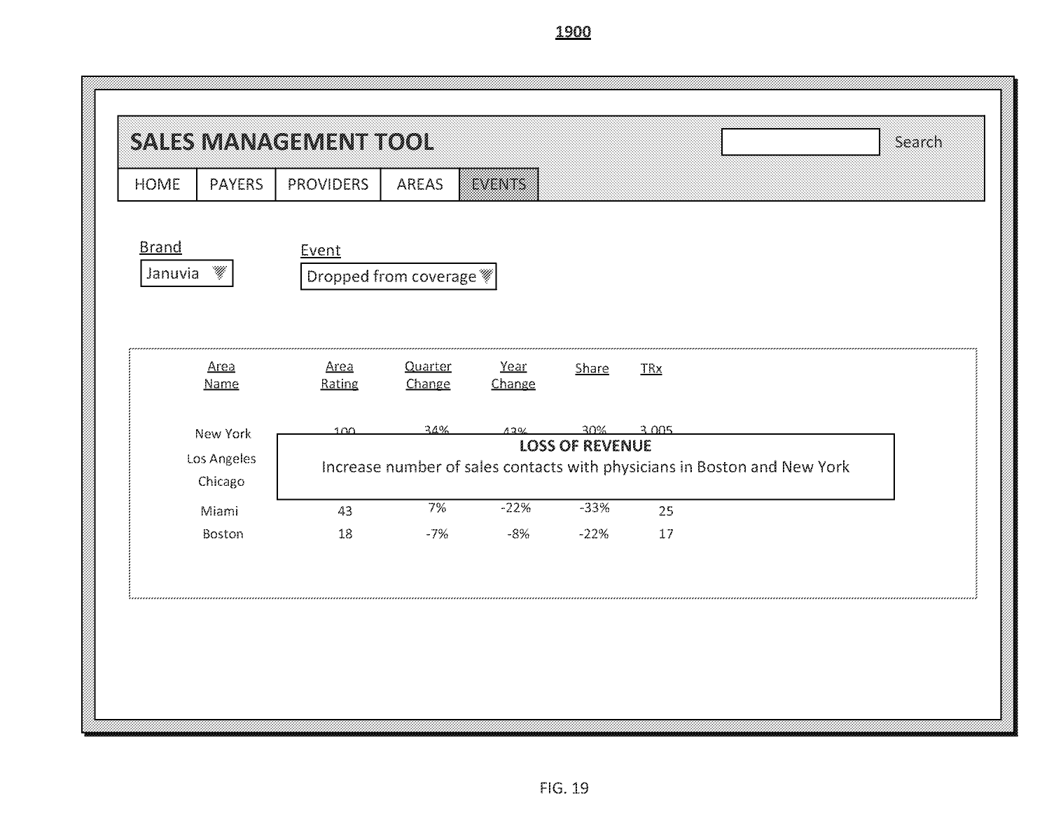

FIG. 19 illustrates an example user interface 1900 that displays the events tab of a web application for a sales management tool. FIG. 19 may be displayed when the user selects the event tab on the task pane.

The events page may include one or more drop down tab options. The drop down tabs may be used to specify a particular product and an event. The event drop down tab options may include a list of negative events that may affect the marketshare of a product in the market place. For the example illustrated in FIG. 19, the user selects the event option “dropped from coverage” and selects Januvia from the drop down brand options. A negative event may be any event that has a negative impact on the marketshare value for a product in a territory. For example, a negative event may include a product being dropped from coverage by an insurance company, a recall of a product, changing in the health care laws/structure (health care reform), or the launch of a new competitive product. The system is able to predict changes in the marketshare based on the occurrence of a negative event, and generate marketing strategies to try to minimize the loss in revenue. The web application generates a page with detailed data across geographic locations and the present marketshare of the selected product in the geographic locations. The data may include the area rating for the identified areas, the quarter change in marketshare data, the marketshare, and the total number of prescriptions. The data displayed may be determined from the prescription data, insurance data, pharmaceutical purchase data and longitudinal prescription data received by the computing systems of the analytical infrastructure system.

The data processing module at the computing systems at the analytical infrastructure may generate a marketing investment plan based on the occurrence of the selected negative event. For the example illustrated in FIG. 19 the user selects the negative event as the selected product, Januvia product being dropped from coverage in the identified geographic locations. In some implementations, the user may use a drop down tab option to identify one or more specific geographic locations of interest. In other implementations, the data display may represent nationwide marketshare data. The computing systems at the analytical infrastructure may use accessed historical sales and sales data related to negative events that may have occurred in the past. The data processing module at the computing systems uses the accessed sales data to identify a marketing opportunity that may be implemented to address the occurrence of the negative event. For the example illustrated in FIG. 19, the user interface displays an indicator message that indicates a loss of revenue would if Januvia was dropped from coverage by the areas shown. The indicator message may include a marketing investment plan that is generated by the data processing module. The marketing investment plan may include marketing strategies that may be used to minimize the loss of revenue predicted by the occurrence of the selected negative event. For the example illustrated in FIG. 19, the marketing investment plan displayed in the indicator message. The marketing investment plan may include marketing strategies which may be used to minimize the predicted loss in revenue. As illustrated in FIG. 19, the marketing plan recommends increasing the number of sale contacts with physicians in Boston and New York. For example, the marketing plan may recommend increasing the contact with physicians from once a quarter to three times a quarter. The market investment plan may include further details for the recommended marketing strategies. In some implementations, the data processing module at the computing systems at the analytical infrastructure may generate one or more marketing investment plans and displays the corresponding predicted loss of revenue for each recommended marketing plan. In some implementations, the sales management tool may indicate the decrease in marketshare that occurred with the last occurrence of a negative event. For example, the last occurrence of a product being dropped in the identified areas or in areas across the nation.

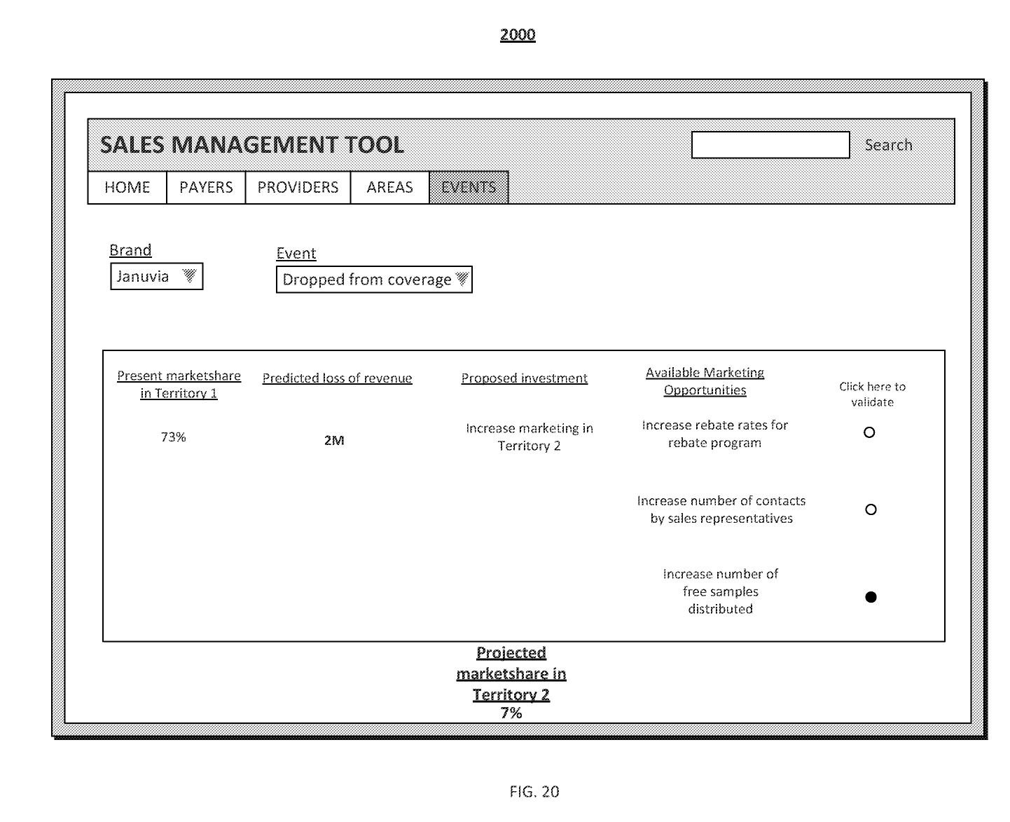

FIG. 20 illustrates an example user interface 2000 that displays the events tab of a web application for a sales management tool. FIG. 20 may be displayed when the user selects the indicator message displayed in FIG. 19. The page displayed may include detailed marketing investment plan data. The data may include the present marketshare of the specified product in territory 1 and the predicted loss of revenue based on the occurrence of the selected negative event, the proposed investment, the available marketing opportunities and the projected marketshare in the territory 2.

For the example illustrated in FIG. 20, the present marketshare in territory 1 is 73% and the predicted loss of revenue based on the occurrence of a negative event is 2M. The data processing module at the computing systems at the analytical infrastructure may generate a proposed investment and further generate available marketing opportunities based on accessed historical sales data. For the example illustrated in FIG. 19, the marketing investment proposed increasing the number of contacts with physicians by the sales representatives in New York and Boston. In some implementations, the page illustrated in FIG. 20 is illustrated when the user selects the indicated presented in FIG. 19. The proposed investment to increase the marketing in territory 2, for the example shown in FIG. 19, New York and/or Boston, may include one or more available marketing opportunities. As illustrated in FIG. 20 the available marketing opportunities includes, an increase in rebate rates for the rebate program, an increase in the number of contacts by sales representatives, and an increase in the number of free samples distributed. In some implementations, the available marketing opportunities displayed may only include marketing opportunities that include a minimum increase in marketshare by a minimum of 2%. The available marketing opportunities displayed may include marketing strategies commonly used by pharmaceutical companies. The webpage may also include a field to allow the user to select the proposed investment. As illustrated in FIG. 20, the user selects to increase the number of samples. In some implementations, the data processing module at the computing systems at the analytical infrastructure may dynamically generate the projected increase in marketshare by implementing the selected marketing opportunity. The webpage may display the projected increase in marketshare for each displayed marketing opportunity. As illustrated in FIG. 20, the corresponding marketshare increase in the selected territories, when the user selects to increase the number of samples distributed to the territories, is 7%. In some implementations, the increase in marketshare may be displayed as a dollar value, for example, 2M.

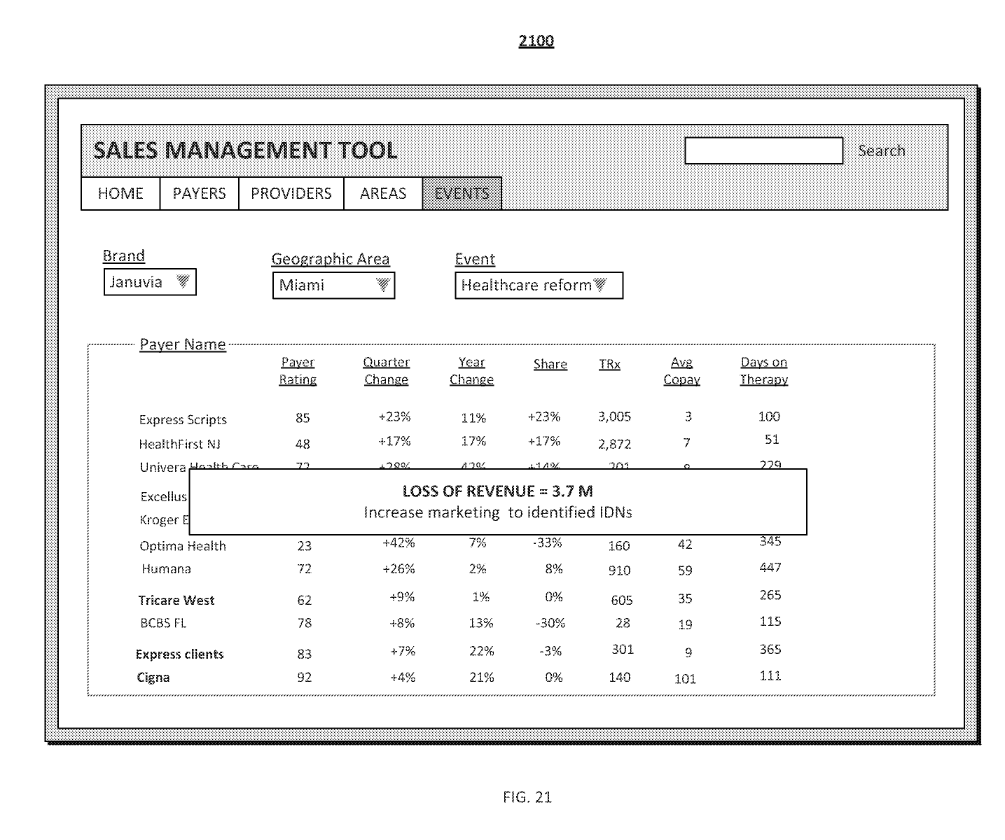

FIG. 21 illustrates an example user interface 2100 that displays the events tab of a web application for a sales management tool. FIG. 21 may be displayed when the user selects the event tab on the task pane.

The events page may include one or more drop down tab options. The drop down tabs maybe used to specify a particular product, an event and a specific geographic location. As illustrated in FIG. 21, the user selects the product Januvia, the Miami area and the event as health care reform. The webpage application generates a page with detailed data for the Integrated Delivery Networks (IDNs) in the Miami area that support the product and may be affected by health care reform. In some implementations, the data may include data for the IDNs across the nation. The data displayed may include the payer rating for the IDNs, the quarter change, the marketshare for each IDN, the total prescription for each IDN. In some implementations the data displayed may include data relating to the different tier plans within each identified IDN. In these implementations, the data displayed may demonstrate how each different tier plan may be affected differently by health care reform. For example, a tier one plan with Tricare may experience a 2% decrease, whereas a tier 3 plan may experience a 13% decrease.

The data processing module at the computing systems at the analytical infrastructure may generate a marketing investment plan based on the occurrence of the selected negative event. The computing systems at the analytical infrastructure may use accessed historical sales and sales data that relates to negative events that may have occurred in the past. The data processing module at the computing systems uses the accessed sales data and other data to identify one or more marketing opportunities that may be implemented to address the occurrence of health care reform. As illustrated in FIG. 21, the user interface displays an indicator message that indicates a loss of revenue of 3.7 M with the occurrence of health care reform. The indicator message may include a marketing investment plan generated by the data processing module at the computing systems of the analytical infrastructure. As illustrated in FIG. 21, the indicator message includes the marketing investment plan of increasing marketing to the identified IDNs. The identified IDNs are highlighted in bold, Tricare West, Express clients and Cigna. In some implementations, the user may select on the indicator message and the user may be directed to the webpage illustrated in FIG. 20.

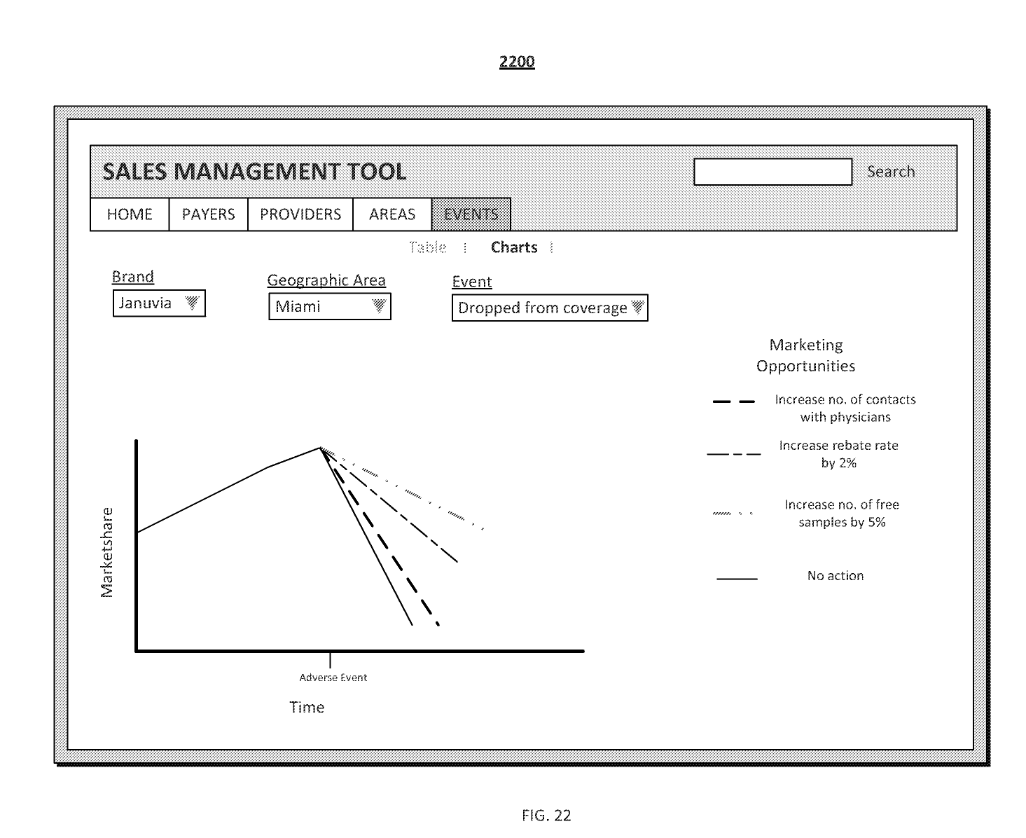

FIG. 22 illustrates an example user interface 2200 that displays the events tab of a web application for a sales management tool. FIG. 22 may be displayed when the use selects the event tab on the task pane and then selects the charts sub tab.

The charts page may include one or more charts used to illustrate the effect of the negative event and the subsequent marketing opportunities on the marketshare of the specified product. The chart display in the user interface may be dynamically generated by the data processing module at the computing systems at the analytical infrastructure, based on the marketshare of the selected product in the selected geographical location and the selected negative event. As illustrated in FIG. 22, the user selected the brand Januvia, the Miami area and the event “dropped from coverage.” The chart displays the predicted decrease in marketshare based on the specified product being dropped from coverage by one or more insurance companies or IDNs within the geographic locations. The chart further includes the predicted change in marketshare that may occur by the implementation of a marketing strategy. The example illustrated in FIG. 22 includes the values for three different marketing opportunities, an increase the number of contacts by sales representatives with physicians, an increase rebate rate by 2%, an increase number of free samples by 5%. The chart may display the effect on the marketshare made only by the selected marketing opportunity.

The user may select the marketing opportunity that is predicted to produce the highest increase in marketshare and this marketing opportunity may be graphed. The user may adjust values within the marketing opportunities and the computing systems at the analytically infrastructure would dynamically generate predicted marketshare values based on the adjusted values and display to the user. For example, the user may adjust the increase rebate rate from 2% to 10% and the updated graph is displayed to the user. In some implementations, the user may select to have display graphically the adjusted values to view the values side for example. The user may select to graph increasing rebate rate by 2% and increasing rebate by 10% and the user can view the change in marketshare based on the two predictions. The predicted increase in marketshare may be displayed as the values for the dynamically generated graphs. For example, the increase the rebate rate by 2% may increase the marketshare by 0.3M and increasing the rebate rate by 10% may increase the marketshare by 0.8M

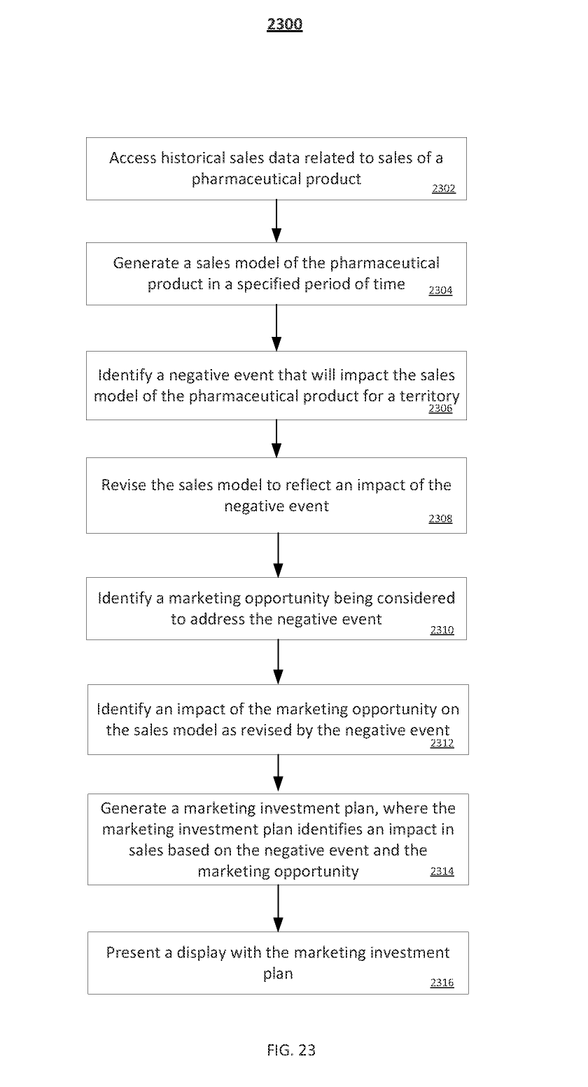

FIG. 23 is a flow chart of a process by which the analytical infrastructure presents a marketing investment plan based on the occurrence of a negative event.

The analytical infrastructure accesses historical data related to sales of a pharmaceutical product (2302). The computing systems at the analytical infrastructure may access sales data from pharmacies or other distribution centers that record the sale of pharmaceutical products. The sales data may include information on the number free samples of the product that was distributed to physicians and the number of coupons or vouchers for the product distributed to physicians. The historical sales data accessed may be sales data for a particular geographical location, or the sales data may be sales data for one or more geographical locations. The historical sales data accessed by the analytical infrastructure may be sales data based on nationwide sales of a particular product. The computing systems at the analytical infrastructure may save the sales data related to sale of the particular product.

The analytical infrastructure generates a sales model of the pharmaceutical product in a specified period of time (2304). The data processing module at the analytical infrastructure computing system processes the accessed historical sales data. In processing the data, the data processing module may filter and/or mine the historical sales data for specific information. The data processing module may filter and/or mine the historical data for sales data for a specified period of time. The data processing module may filter and/or mine the historical sales data for a specified geographic location. In other implementations, the data processing module may filter and/or mine the historical sales data for one or more geographical locations.

The analytical infrastructure identifies a negative event that will impact the sales model of the pharmaceutical product for a territory (2306). The computing systems at the analytical infrastructure may store information that relates to the occurrence of a negative event in the market place that affects the sales data for a product. In some implementations, the computing systems at the analytical infrastructure may access historical sales data for a specific pharmaceutical product and map the trends in the sales data for a period of time to the occurrence of different events. For example, the computing systems at the analytical infrastructure may access sales information for a product over the period of ten years and map the occurrence of healthcare reform to the sale of the product. The data processing module at the computing systems may identify the type of events that impact the sales of a product based on historical sales data and the mapping of different events. The computing systems at the analytical infrastructure may save the sales data that relates to the occurrence of an even in the market place as event sales data.

The analytical infrastructure revises the sales model to reflect an impact of the negative event (2308). The data processing module at the computing systems of the analytical infrastructure may process the event data and the historical sales data to generate a sales model that reflects the occurrence of an event. The data processing module may filter and/or mine the event data over a specified period of time. The analytical infrastructure identifies a marketing opportunity being considered to address the negative event (2310). The computing systems at the analytical infrastructure may access from storage information related to marketing strategies. The computing systems may have accessed marketing strategy information from pharmaceutical or biotechnology companies promoting and selling a specific pharmaceutical product. The marketing strategies may be used by the computing systems at the analytical infrastructure to identify a marketing opportunity that may be used to address the occurrence of an event.

The analytical infrastructure identifies an impact of the marketing opportunity on the sales model as revised by the negative event (2312). The computing systems at the analytical infrastructure may access marketing information reported by pharmaceutical companies. The marketing information accessed may be used to evaluate the success of a marketing strategy. The data processing module at the computing systems of the analytical infrastructure may use the marketing strategy data to apply to the revised sales model. In some implementations, the data processing module can assess the probability of success of a marketing strategy after the occurrence of a negative event.

The analytical infrastructure generates a marketing investment plan, where the marketing investment plan identifies an impact in sales based on the negative event and the marketing opportunity (2314). The computing systems at the analytical infrastructure may use the historical sales data and sales data related to a negative event and marketing data to generate a marketing investment plan. The data processing module may generate one or more investment plans. In these implementations, the data processing module may generate a predicted marketshare value for each marketing investment. The analytical infrastructure presents a display with the marketing investment plan (2316). The data processing module at the computing systems of the analytical infrastructure presents the generated marketing investment based on the occurrence of a negative event. In some implementations, the system may present one or more marketing investment plans. The user may select the marketing investment that best fits the business need of the particular user.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network, for example, shared or private computing clouds. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

Pharmaceuticals in various implementations need not necessarily be heavily controlled, and the methods presented herein equally apply to over-the-counter drugs or even potentially to herbal preparations or nutritional supplements that have the potential to have an impact on medical treatment. The use of St. John's Wort to treat a patient with clinical depression may be considered by an implementation, as may a nutritional supplement such as fish oil or a prescription antidepressant.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method comprising:
accessing historical sales data related to sales of a pharmaceutical product;
generating, based on accessing the historical sales data, a sales model of the pharmaceutical product in a specified period of time;
identifying a negative event that will impact the sales model of the pharmaceutical product for a territory;
revising the sales model to reflect an impact of the negative event;
identifying a marketing opportunity being considered to address the negative event;
identifying an impact of the marketing opportunity on the sales model as revised by the negative event;
generating, based on identifying an impact of the marketing opportunity on the sales model, a marketing investment plan, wherein the marketing investment plan identifies an impact in sales based on the negative event and the marketing opportunity;
presenting a display with the marketing investment plan.

2. The computer-implemented method of claim 1 wherein generating a marketing investment plan based on the impact of the marketing opportunity comprises generating a marketing investment plan that reduces the impact.

3. The computer-implemented method of claim 1 wherein generating a marketing investment plan based on the impact of the marketing opportunity comprises generating a marketing investment plan that preserves the marketshare.

4. The computer-implemented method of claim 1 wherein revising the sales model to reflect the impact of the negative event comprises revising the sales model based on an occurrence of a negative event in the past.

5. The computer-implemented method of claim 1 wherein identifying a negative event that will impact the sales model of the pharmaceutical product for a marketplace comprises identifying a change in coverage for the particular product in an IDN (“Integrated Delivery Network”) plan.

6. A system comprising:
one or more computers and one or more storage devices storing instructions that are operable, when executed by one or more computers, to cause the one or more computers to perform operations comprising:
accessing historical sales data related to sales of a pharmaceutical product;
generating, based on accessing the historical sales data, a sales model of the pharmaceutical product in a specified period of time;
identifying a negative event that will impact the sales model of the pharmaceutical product for a territory;
revising the sales model to reflect an impact of the negative event;
identifying a marketing opportunity being considered to address the negative event;
identifying an impact of the marketing opportunity on the sales model as revised by the negative event;
generating, based on identifying an impact of the marketing opportunity on the sales model, a marketing investment plan, wherein the marketing investment plan identifies an impact in sales based on the negative event and the marketing opportunity;
presenting a display with the marketing investment plan.

7. The system of claim 6 wherein generating a marketing investment plan based on the impact of the marketing opportunity comprises generating a marketing investment plan that reduces the impact.

8. The system of claim 6 wherein generating a marketing investment plan based on the impact of the marketing opportunity comprises generating a marketing investment plan that preserves the marketshare.

9. The system of claim 6 The computer-implemented method of claim 1, wherein revising the sales model to reflect the impact of the negative event comprises revising the sales model based on an occurrence of a negative event in the past.

10. The system of claim 6 wherein identifying a negative event that will impact the sales model of the pharmaceutical product for a marketplace comprises identifying a change in coverage for the particular product in an IDN (“Integrated Delivery Network”) plan.

11. A non-transitory computer-readable medium storing software comprising instructions executable by one or more which, upon such execution, cause the one or more computers to perform operations comprising:
accessing prescription data associated with a plan for an Integrated Delivery Network in a specified geographic location, wherein the prescription data associated with the Integrated Delivery Network is descriptive of prescribing behavior of one or more prescribers servicing patients associated with the plan for the Integrated Delivery Network;
accessing historical sales data related to sales of a pharmaceutical product;
generating, based on accessing the historical sales data, a sales model of the pharmaceutical product in a specified period of time;
identifying a negative event that will impact the sales model of the pharmaceutical product for a territory;
revising the sales model to reflect an impact of the negative event;
identifying a marketing opportunity being considered to address the negative event;
identifying an impact of the marketing opportunity on the sales model as revised by the negative event;
generating, based on identifying an impact of the marketing opportunity on the sales model, a marketing investment plan, wherein the marketing investment plan identifies an impact in sales based on the negative event and the marketing opportunity;
presenting a display with the marketing investment plan.

12. The medium of claim 11 wherein generating a marketing investment plan based on the impact of the marketing opportunity comprises generating a marketing investment plan that reduces the impact.

13. The medium of claim 11 wherein generating a marketing investment plan based on the impact of the marketing opportunity comprises generating a marketing investment plan that preserves the marketshare.

14. The medium of claim 11 wherein revising the sales model to reflect the impact of the negative event comprises revising the sales model based on an occurrence of a negative event in the past.

15. The medium of claim 11 wherein identifying a negative event that will impact the sales model of the pharmaceutical product for a marketplace comprises identifying a change in coverage for the particular product in an IDN (“Integrated Delivery Network”) plan.
